(19) United States
(12) Patent Application Publication
(10) Pub. No.: US 2014/0055860 A1
(43) Pub. Date: Feb. 27, 2014

(54) Lens Unit Manufacturing Method, Lens Array, and Lens Unit

(71) Applicants: Tomoyuki Morimoto, Hachioji-shi (JP); Takashi Sannokyou, Hachioji-shi (JP); Hiroshi Nagoya, Fuchu-shi (JP); Hiroumi Tanigawa, Hachioji-shi (JP); Hiroyuki Matsuda, Sagamihara-shi (JP); Toshiyuki Imai, Hachioji-shi (JP); Sadaharu Honda, Hachioji-shi (JP); Takahiro Mizukane, Fuchu-shi (JP); Kojiro Takatori, Kobe-shi (JP); Shuhei Ashida, Hachioji-shi (JP)

(72) Inventors: Tomoyuki Morimoto, Hachioji-shi (JP); Takashi Sannokyou, Hachioji-shi (JP); Hiroshi Nagoya, Fuchu-shi (JP); Hiroumi Tanigawa, Hachioji-shi (JP); Hiroyuki Matsuda, Sagamihara-shi (JP); Toshiyuki Imai, Hachioji-shi (JP); Sadaharu Honda, Hachioji-shi (JP); Takahiro Mizukane, Fuchu-shi (JP); Kojiro Takatori, Kobe-shi (JP); Shuhei Ashida, Hachioji-shi (JP)

(21) Appl. No.: 13/988,483

(22) PCT Filed: Oct. 9, 2012
(86) PCT No.: PCT/JP2012/076134

§ 371 Date: Jul. 25, 2013

(30) Foreign Application Priority Data
Oct. 31, 2011 (JP) 2011-238303
May 9, 2012 (JP) 2012-107629

(51) Int. Cl. G02B 13/00; G02B 7/02

(52) U.S. Cl. CPC G02B 13/0015; G02B 7/02
USPC 359/619; 29/559; 156/250

(57) ABSTRACT

To provide a lens unit producing method capable for positioning a lens array with high precision over a long period of time, a lens array, and a lens unit. When the first flat surfaces LA1f come in contact with the respective tapered surfaces HLD1, the glass lens array LA1 cannot rotate more than that for the holder HLD. Meanwhile, since the tapered surfaces HLD1 are regulated by the respective opposite first flat surface LA1f, the glass lens array LA1 cannot move more than that relatively to the holder HLD. That is, by holding the glass lens array LA1 with the holder HLD, the glass lens array LA1 can be positioned with high precision for the holder HLD.

### TECHNICAL FIELD

The present invention relates to a lens unit producing method, a lens array, and a lens unit.

### BACKGROUND ART

Compact and very thin image pickup devices (hereafter, also called a camera module) are employed for mobile terminals such as mobile telephones, PDA, and smart phones, which are compact and thin electric devices, such as mobile telephones and PDA (Personal Digital Assistant). As image pickup elements used for these image pickup devices, solid state image pickup elements such as CCD image sensors and CMOS image sensors are known. In recent years, the image pickup elements have been developed to make a density of pixels higher in order to attain higher image resolution and higher performance. Further, an image pickup lens to form an image of an object on these image pickup elements is required to be made compact in response to the miniaturization of image pickup elements, and such requirement tends to become stronger from year to year.

With regard to a lens unit used for such an image pickup device to be incorporated in a mobile terminal, according to the known method as disclosed in Patent Document 1, for example, a lens unit is produced in such a way that a pair of glass lens arrays each of which includes multiple linked lenses are molded from glass by molding dies, then, the respective axes of the lenses are aligned based on the respective ribs molded at the same time, and thereafter, the pair of glass lens arrays are pasted to each other, and cut out for each of the lenses into lens units.

### PRIOR ART DOCUMENT

### Patent Document

Patent document 1: International Patent Publication No. 2011/093502 Pamphlet
Patent document 2: Japanese Patent publication No: 2004-323589

### SUMMARY OF INVENTION

### Problems to be Solved by Invention

According to the technique of Patent document 1, the respective axes of the lenses can be aligned with high precision based on the respective ribs of the glass lens arrays. However, at the time of forming a groove portion to mold the rib in the molding dies for molding the glass lens array by machining, since the shape and attitude of a tool are restricted, there are problems that it may be difficult to perform the machining with high precision. Further, when the molding dies have been used for a long period of time, abrasion and chips may take place on the edge of the groove portion, which results in that the shape of the molded rib deforms and there is possibility that it becomes difficult to perform positioning with high precision. Accordingly, the molding die is needed to be replaced with a spare one in a comparatively short maintenance cycle, which takes cost and labor hour.

On the other hand, as disclosed in Patent Document 2, an outer wall on the periphery of a lens optical surface is shaped in a cylinder, and the outer wall may be used as a reference surface for positioning. However, there are the following problems. For example, in the case of forming the lens by the reheating molding method, if a regulator is disposed in order to enhance the shape accuracy of the outer wall, the shape of the optical surface and the configuration of the periphery of the outer wall may collapse. Accordingly, the size administration of a preform and the optimization of the molding condition take so much time. On the other hand, in the case of forming the lens by the liquid droplet molding method, there are problems that the slippage of a liquid dropping position influences also the configuration of the outer wall.

The present invention has been achieved in view of the problems of the conventional techniques, and an object of the present invention is to provide a lens unit producing method capable for positioning a lens array with high precision over a long period of time, a lens array, and a lens unit.

### Solution to Problems

In a lens unit producing method for producing a lens unit from a lens array, wherein in the lens array, a bottom surface including a plurality of optical surfaces and an inner peripheral surface disposed on a periphery of the bottom surface so as to surround the optical surfaces are molded integrally by a molding die, and the inner peripheral surface includes a first flat surface not orthogonal to each of the respective optical axes of the optical surfaces; a lens unit producing method described in claim 1 is characterized by comprising:

a process of moving a holder comprising an outer peripheral surface including a second flat surface and an end surface relatively to the lens array in such a way that the first flat surface and the second flat surface are made approximately parallel to each other and the bottom surface and the end surface are made approach each other in a state that the outer peripheral surface is surrounded by the inner peripheral surface; and

a process of holding the lens array with the holder, and then positioning the lens array by moving the holder.

According to the present invention, the holder is moved relatively to the lens array such that the first flat surface and the second flat surface are made approximately parallel to each other and the bottom surface and the end surface are made approach each other in a state that the outer peripheral surface is surrounded by the inner peripheral surface. Accordingly, the movement of the lens array is limited for the holder within a range that the outer peripheral surface is surrounded by the inner peripheral surface. In particular, in the state that the first flat surface and the second flat surface face each other, the rotation of the lens array is obstructed. As a result, the lens array can be positioned for the holder with high precision. As the length of each of the first flat surface and the second flat surface is made longer, the rotation obstructing effect becomes higher. Further, with regard to the lens array, as long as at least only the inner peripheral surface is molded with high precision, even if an excessive raw material protrudes to outside, since the outer configuration does not influence the precision of positioning, it is permissible for the outer configuration to be a naturally-formed state. Accordingly, even if the volume of the raw material is not severely administrated, the positioning can be performed with high precision. Further, even if the edge of the molding die of the lens array abrades away or chips, there is no possibility that the surface configuration of the inner peripheral surface of the lens array is influenced. Accordingly, the positioning can be performed stably for a long period of time. Incidentally, a part of the inner peripheral surface may be discontinuous in a circumferential direction. The term “approximately parallel” includes the case of an inclined state within ±5° with respect to a parallel state.

In the invention described in claim 1, the lens unit producing method described in claim 2 is characterized in that two sets of the lens arrays and the holders are prepared, and the lens unit producing method further comprises:

a process of positioning one of the two lens arrays held by one of the two holders to another one of the two lens arrays held by another one of the two holders, and then, pasting the two lens arrays to each other; and

a process of fixing the pasted two lens arrays by using the respective first flat surfaces and cutting the two lens arrays for each of the optical surfaces.

By performing the above processes, lens units in each of which the respective optical surfaces of the lens arrays are combined with high precision are produced efficiently. In particular, by utilizing the first flat surfaces at the time of cutting, since a plurality of lens arrays are cut out at one time with high precision, it is preferable.

In the invention described in claim 2, the lens unit producing method described in claim 3 is characterized in that the lens unit producing method further comprises:

a process of holding the pasted two or more lens arrays by one of the two holders, holding another lens array by another one of the two holders, positioning the two holders to each other, and thereafter, pasting the another lens array and the pasted two or more lens arrays to each other.

According to the present invention, three or more lens arrays are positioned to each other with high precision, and superimposed and pasted onto each other. Thereafter, the three or more lens arrays are cut out at one time into lens units. Accordingly, high production efficiency can be secured.

In the invention described in any one of claims 1 to 3, the lens unit producing method described in claim 4 is characterized in that the first flat surface is made incline with respect to the respective optical axes of the optical surfaces.

For example, in the case where the material of the lens array is resin and the like, even if the first flat surface is parallel to the optical axis of the optical surface, when shrinkage occurs at the time of molding, since the lens array made of resin may elastically deform to some degree, it becomes possible to release the lens array from the molding die. However, in the case where the material of the lens array is glass, since the lens array made of glass may not elastically deform, when shrinkage occurs at the time of molding, the lens array comes strongly in close contact with the molding die, which results in that it become difficult to release the lens array from the molding die. In contrast, if at least the first flat surface is made incline with respect to the optical axis of the optical surface, since it becomes easy to release the lens array from the molding die after molding, which is preferable.

In the invention described in claim 4, the lens unit producing method described in claim 5 is characterized in that the first flat surface has a taper angle of 10° to 60° with respect to each of the respective optical axes of the optical surfaces.

If the first flat surface has a taper angle of 10° to 60° with respect to each of the respective optical axes of the optical surfaces, since high positioning precision can be attained, it is preferable. Further, if the first flat surface has a taper angle of 20° to 50° with respect to each of the respective optical axes of the optical surfaces, since more high positioning precision can be attained, it is more preferable. More preferably, the taper angle of the first flat surface with respect to each of the respective optical axes of the optical surfaces is made 45°. With this, the best high positioning precision can be attained.

In the invention described in any one of claims 1 to 5, the lens unit producing method described in claim 6 is characterized in that the first flat surface is prepared by two, and the two first flat surfaces are arranged so as to face each other across the plurality of optical surfaces.

If the first flat surface is prepared by two and the two first flat surfaces are arranged so as to face each other across the plurality of optical surfaces, positioning precision between the two first flat surfaces can be enhanced.

In the invention described in any one of claims 1 to 5, the lens unit producing method described in claim 7 is characterized in that the first flat surface is prepared by four, and the four first flat surfaces are arranged so as to surround the plurality of optical surfaces, and the respective axes of two neighboring first flat surfaces of the four first flat surfaces are orthogonal to each other.

If the first flat surface is prepared by four, the four first flat surfaces are arranged so as to surround the plurality of optical surfaces, and the respective axes of two neighboring first flat surfaces of the four first flat surfaces are orthogonal to each other; the inner peripheral surface of the lens array becomes close to a square shape. With this, positioning within a surface orthogonal to each of the respective axes of the optical surfaces can be performed with high precision. At this time, it is preferable that the respective lengths of the four first flat surfaces are equal to each other. Further, if the number of first flat surfaces to surround the plurality of optical surfaces is made 8 or more, since an amount of shrinkage of the material at the time of molding of the lens array becomes isotropic, it is preferable.

In the invention described in any one of claims 1 to 7, the lens unit producing method described in claim 8 is characterized in that when the lens array is held by the holder, a clearance of 10 μm or less is formed between the first flat surface and the second flat surface.

By forming a clearance of 10 μm or less between the first flat surface and the second flat surface, it becomes easy to insert the outer peripheral surface of the holder into the inner peripheral surface of the lens array. Further, since such a clearance is comparatively small, an error of the lens array to the holder becomes small. Accordingly, there is no possibility that the position precision is lowered greatly. Incidentally, the clearance is not necessarily limited to “10 μm or less”. If the clearance is determined in accordance with another alignment standard, the determined value may be employed.

In the invention described in claim 8, the lens unit producing method described in claim 9 is characterized in that when the lens array is held by the holder, the end surface is brought in contact with the bottom surface other than the optical surfaces.

When the lens array is held by the holder, the end surface is brought in contact with the bottom surface other than the optical surfaces, whereby a positioning error in the insertion direction between the lens array and the holder can be made small.

In the invention described in any one of claims 1 to 9, the lens unit producing method described in claim 10 is characterized in that an R portion or a chamfered portion is provided between the first flat surface and the bottom surface in the lens array.

Since a portion between the first flat surface and the bottom surface in the lens array is concave, a corner portion molding portion of the molding die to mold the above portion becomes convex. Accordingly, if the corner portion molding portion is shaped in an edge, there is possibility that abrasion and chips takes place due to use for a long period of time. In contrast, if an R portion or a chamfered portion is formed between the first flat surface and the bottom surface in the lens array, the corner portion molding portion of the molding die is also shaped in a smooth configuration corresponding to the R portion or the chamfered portion. As a result, the molding can be performed with high precision over a long period of time. Here, the R portion is a configuration in which a cross section is smoothly connected with a single arc or a plurality of arcs.

In the invention described in claim 10, the lens unit producing method described in claim 11 is characterized in that an escape portion (roll-off portion) is provided between the second flat surface and the end surface in the holder.

In the case where an R portion or a chamfered portion is formed between the first flat surface and the bottom surface in the lens array, if a portion between the second flat surface and the end surface which faces the R portion or the chamfered portion, is shaped in an edge, there is a possibility that both the edge and the R portion or the chamfered portion may interfere with each other. Then, by forming the escape portion between the second flat surface and the end surface in the holder, it becomes possible to suppress the interference between the both portions, and to attain the positioning with high precision. The “escape portion” includes, for example, a depressed configuration.

In the invention described in any one of claims 1 to 11, the lens unit producing method described in claim 12 is characterized in that a reference surface is formed on the outer periphery of the lens array by using the molding die at the time of molding of the lens array, and a plurality of the lens arrays are aligned and superimposed based on the respective reference surfaces, and cut out for each of the optical surfaces at one time.

In the case where a reference surface is formed on the outer periphery of the lens array by using the molding die at the time of molding of the lens array, when the lens arrays are aligned to each other based on such the reference surfaces, it may be difficult to obtain precision enough to use positioning of the respective optical axes of the optical surfaces. However, with the reference surfaces, it is possible to ensure sufficient precision in terms of positions at which the lens arrays are cut out for each of the optical surfaces. Accordingly, with the technique that a plurality of lens arrays are aligned and superimposed based on the respective reference surfaces and cut out for each of the optical surfaces at one time, the production efficiency of the lens unit can be enhanced.

In a lens array used for producing a lens unit, a lens array described in claim 13 is characterized by comprising:

a bottom surface including a plurality of optical surfaces; and

an inner peripheral surface disposed on a periphery of the bottom surface so as to surround the optical surfaces,

wherein the bottom surface and the inner peripheral surface are molded integrally by a molding die, and the inner peripheral surface includes a first flat surface not orthogonal to each of the respective optical axes of the optical surfaces; and

wherein the lens array is prepared by two, and the two lens arrays are held respectively by two holders each provided with an outer peripheral surface including a second flat surface and an end surface in such a way that the first flat surface and the second flat surface are made approximately parallel to each other and the bottom surface and the end surface are made approach each other in a state that the outer peripheral surface is surrounded by the inner peripheral surface, and then, the two lens arrays are subjected to positioning and pasted to each other, and thereafter, the pasted two lens arrays are cut out for each of the optical surfaces, whereby lens units are produced.

According to the present invention, when the holder is moved relatively to the lens array in such a way that the first flat surface and the second flat surface are made approximately parallel to each other and the bottom surface and the end surface are made approach each other in a state that the outer peripheral surface is surrounded by the inner peripheral surface, the movement of the lens array is limited for the holder within a range that the outer peripheral surface is surrounded by the inner peripheral surface. In particular, in the state that the first flat surface and the second flat surface face each other, the rotation of the lens array is obstructed. As a result, the lens array can be positioned for the holder with high precision. As the length of each of the first flat surface and the second flat surface is made longer, the rotation obstructing effect becomes higher. Further, with regard to the lens array, as long as at least only the inner peripheral surface is molded with high precision, even if an excessive raw material protrudes to outside, since the outer configuration does not influence the precision of positioning, it is permissible for the outer configuration to be a naturally-formed state. Accordingly, even if the volume of the raw material is not severely administrated, the positioning can be performed with high precision. Further, even if the edge of the molding die of the lens array abrades away or chips, there is no possibility that the surface configuration of the inner peripheral surface of the lens array is influenced. Accordingly, the positioning can be performed stably for a long period of time. After the two lens arrays are subjected to positioning and pasted to each other, the two lens arrays are cut out for each of the optical surfaces, whereby lens units with high precision are produced efficiently. At this time, if a plurality of lens arrays are positioned based on the respective first flat surfaces and cut out at one time, the precision of cutting is high and the cutting efficiency is high, which are preferable.

In the invention described in claim 13, the lens array described in claim 14 is characterized in that the first flat surface is made incline with respect to the respective optical axes of the optical surfaces.

For example, in the case where the material of the lens array is resin and the like, even if the first flat surface is parallel to the optical axis of the optical surface, when shrinkage occurs at the time of molding, since the lens array made of resin may elastically deform to some degree, it becomes possible to release the lens array from the molding die. However, in the case where the material of the lens array is glass, since the lens array made of glass may not elastically deform, when shrinkage occurs at the time of molding, the lens array comes strongly in close contact with the molding die, which results in that it become difficult to release the lens array from the molding die. In contrast, if at least the first flat surface is made incline with respect to the optical axis of the optical surface, since it becomes easy to release the lens array from the molding die after molding, which is preferable.

In the invention described in claim 14, the lens array described in claim 15 is characterized in that the first flat surface has a taper angle of 10° to 60° with respect to each of the respective optical axes of the optical surfaces.

If the first flat surface has a taper angle of 10° to 60° with respect to each of the respective optical axes of the optical surfaces, since high positioning precision can be attained, it is preferable. Further, if the first flat surface has a taper angle of 20° to 50° with respect to each of the respective optical axes of the optical surfaces, since more high positioning precision can be attained, it is more preferable. More preferably, the taper angle of the first flat surface to the respective optical axes of the optical surfaces is made 30° to 50°. With this, even if the molding is repeated, no chip takes place on a molding die. As a result, its operating life can be prolonged.

In the invention described in any one of claims 13 to 15, the lens array described in claim 16 is characterized in that the first flat surface is prepared by two, and the two first flat surfaces are arranged so as to face each other across the plurality of optical surfaces.

If the first flat surface is prepared by two and the two first flat surfaces are arranged so as to face each other across the plurality of optical surfaces, positioning precision between the two first flat surfaces can be enhanced.

In the invention described in any one of claims 13 to 15, the lens array described in claim 17 is characterized in that the first flat surface is prepared by four, and the four first flat surfaces are arranged so as to surround the plurality of optical surfaces, and the respective axes of two neighboring first flat surfaces of the four first flat surfaces are orthogonal to each other.

If the first flat surface is prepared by four, the four first flat surfaces are arranged so as to surround the plurality of optical surfaces, and the respective axes of two neighboring first flat surfaces of the four first flat surfaces are orthogonal to each other; the inner peripheral surface of the lens array becomes close to a square shape. With this, positioning within a surface orthogonal to each of the respective axes of the optical surfaces can be performed with high precision. At this time, it is preferable that the respective lengths of the four first flat surfaces are equal to each other. Further, if the number of first flat surfaces to surround the plurality of optical surfaces is made 8 or more, since an amount of shrinkage of the material at the time of molding of the lens array becomes isotropic, it is preferable.

In the invention described in any one of claims 13 to 17, the lens array described in claim 18 is characterized in that when the lens array is held by the holder, the lens array has dimensions such that a clearance of 10 μm or less is formed between the first flat surface and the second flat surface.

By forming a clearance of 10 μm or less between the first flat surface and the second flat surface, it becomes easy to insert the outer peripheral surface of the holder into the inner peripheral surface of the lens array. Further, since such a clearance is comparatively small, an error of the lens array to the holder becomes small. Accordingly, there is no possibility that the position precision is lowered greatly. Incidentally, the clearance is not necessarily limited to “10 μm or less”. If the clearance is determined in accordance with another alignment standard, the determined value may be employed.

In the invention described in claim 18, the lens array described in claim 19 is characterized in that when the lens array is held by the holder, the end surface is brought in contact with the bottom surface other than the optical surfaces.

When the lens array is held by the holder, the end surface is brought in contact with the bottom surface other than the optical surfaces, whereby a positioning error in the insertion direction between the lens array and the holder can be made small.

In the invention described in any one of claims 13 to 19, the lens array described in claim 20 is characterized in that an R portion or a chamfered portion is provided between the first flat surface and the bottom surface in the lens array.

Since a portion between the first flat surface and the bottom surface in the lens array is concave, a corner portion molding portion of the molding die to mold the above portion becomes convex. Accordingly, if the corner portion molding portion is shaped in an edge, there is possibility that abrasion and chips takes place due to use for a long period of time. In contrast, if an R portion or a chamfered portion is formed between the first flat surface and the bottom surface in the lens array, the corner portion molding portion of the molding die is also shaped in a smooth configuration corresponding to the R portion or the chamfered portion. As a result, the molding can be performed with high precision over a long period of time. Here, the R portion is a configuration in which a cross section is smoothly connected with a single arc or a plurality of arcs.

In the invention described in any one of claims 13 to 20, the lens array described in claim 21 is characterized in that the material of the lens array is glass. However, resin may be used in place of glass.

In the invention described in any one of claims 13 to 21, the lens array described in claim 22 is characterized in that the lens array has a reference surface formed on an outer periphery at the time of molding by using the molding die.

By forming the reference surface on the outer periphery of the lens array by using the molding die at the time of molding of the lens array, a plurality of the lens arrays are aligned and superimposed based on the respective reference surfaces and cut out for each of the optical surfaces at one time, whereby the production efficiency of the lens units can be enhanced.

A lens unit described in claim 23 is characterized by being formed by a process of preparing the lens array described in any one of claims 13 to 22 by multiple pieces, superimposing the multiple lens arrays, and cutting the superimposed multiple lens arrays.

The pasted two or more lens arrays are held by one of the two holders, another lens array is held by another one of the two holders, the two holders are subjected to positioning relatively to each other, and the aligned lens array is passed on the two or more lens arrays. With the above processes, not only two lens arrays, but also three or more lens arrays can be positioned to each other with high precision and pasted to each other.

A lens unit described in claim 24 is characterized by being formed by preparing the lens array described in claim 22 by multiple pieces, aligning and superimposing the multiple lens arrays based on the respective reference surfaces, and cutting the superimposed multiple lens arrays for each of the optical surfaces at one time.

The multiple lens arrays are aligned and superimposed based on the respective reference surfaces, and cut out for each of the optical surfaces at one time, whereby the production efficiency of the lens units can be enhanced.

### Effect of Invention

According to the present invention, it becomes possible to provide a lens unit producing method capable for positioning a lens array with high precision over a long period of time, a lens array, and a lens unit.

### BRIEF DESCRIPTION OF THE DRAWINGS

FIG. 1 is an illustration showing a process of molding a lens array used in the present embodiment by using molding dies, (a) indicates a state that a glass GL is dropped from a nozzle NZ to a lower molding die 20, and (b) shows an upper molding die 10.

FIG. 2 is an illustration showing a process of molding a lens array used in the present embodiment by using molding dies, and indicates a state that molding is achieved by molding dies.

FIG. 3 is an illustration showing a process of molding a lens array used in the present embodiment by using molding dies, and indicates a state after the lens array is released from the molding dies.

FIG. 4 is a perspective view of the state after the lens array is released from the molding dies.

FIG. 5 is a perspective view of the front side of a first glass lens array LA1.

FIG. 6 is a perspective view of the back side of the first glass lens array LA1.

FIG. 7 is a cross-sectional view of the first glass lens array LA1.

FIG. 8 is a cross-sectional view showing holders HLD which hold the respective back surfaces of the glass lens arrays LA1.

FIG. 9 is a perspective view of the holders HLD.

FIG. 10 is a partially-expanded cross-sectional view in a state that the glass lens array LA1 is held by the holder HLD.

FIG. 11 is an illustration showing a process of forming an intermediate fabrication component IM.

FIG. 12 is a perspective view of a lens unit obtained from the intermediate fabrication component IM.

FIG. 13 is a perspective view of an image pickup device 50 which employs the lens unit according to the present embodiment.

FIG. 14 is a cross-sectional view in which the structure shown in FIG. 13 is cut out along a XIV-XIV line with arrows, and the cut-out portion is looked in the arrow direction.

FIG. 15 is an illustration showing a state that the image pickup device 50 is incorporated in a mobile telephone 100 as a mobile terminal being a digital device, (a) is an illustration in which a folded mobile telephone is opened and the opened mobile telephone is looked from a front side where a liquid crystal display portion DP is disposed, and (b) is an illustration in which a folded mobile telephone is opened and the opened mobile telephone is looked from a back side.

FIG. 16 is a control block diagram of the mobile telephone 100.

FIG. 17 is a perspective view of a glass lens array LA2 according to another embodiment.

FIG. 18 is a perspective view of a glass lens array LA3 according to another embodiment.

FIG. 19 is a perspective view of the front side of a glass lens array LA4 according to another embodiment.

FIG. 20 is a perspective view of the back side of the glass lens array LA4 according to another embodiment.

FIG. 21 is an illustration sowing a glass lens array LA5 according to another embodiment, (a) is an illustration in which the glass lens array LA5 is looked from its back side, and (b) is an illustration in which the structure shown in FIG. 21(a) is cut out along a B-B line and the cut-out portion is looked in an arrow direction.

FIG. 22 is a cross-sectional view showing molding dies to mold a glass lens array LA3 to be pasted onto an intermediate fabrication component.

FIG. 23 is a perspective view of the glass lens array LA3 molded by an upper molding die 10′ and a lower molding die 20.

FIG. 24 is a cross-sectional view showing a holder HLD which holds the back surface of the glass lens array LA1 in the intermediate fabrication component IM and a holder HLD′ which holds the back surface of the glass lens array LA3.

FIG. 25 is a cross-sectional view of a lens unit OU produced by cutting the intermediate fabrication component IM′ shown in FIG. 24 at the respective positions of dotted lines.

FIG. 26 is a cross-sectional view showing a state at the time of molding a glass lens array LA1.

FIG. 27 is an illustration in which the structure shown in FIG. 26 is cut out along a XXVII-XXVII line, and the cut-out portion is looked in the arrow direction.

FIG. 28 is an illustration showing a state that a plurality of intermediate fabrication components IM in each of which a plurality of lens arrays are pasted to each other are placed side by side and cut out at one time.

### EMBODIMENT FOR IMPLEMENTING THE INVENTION

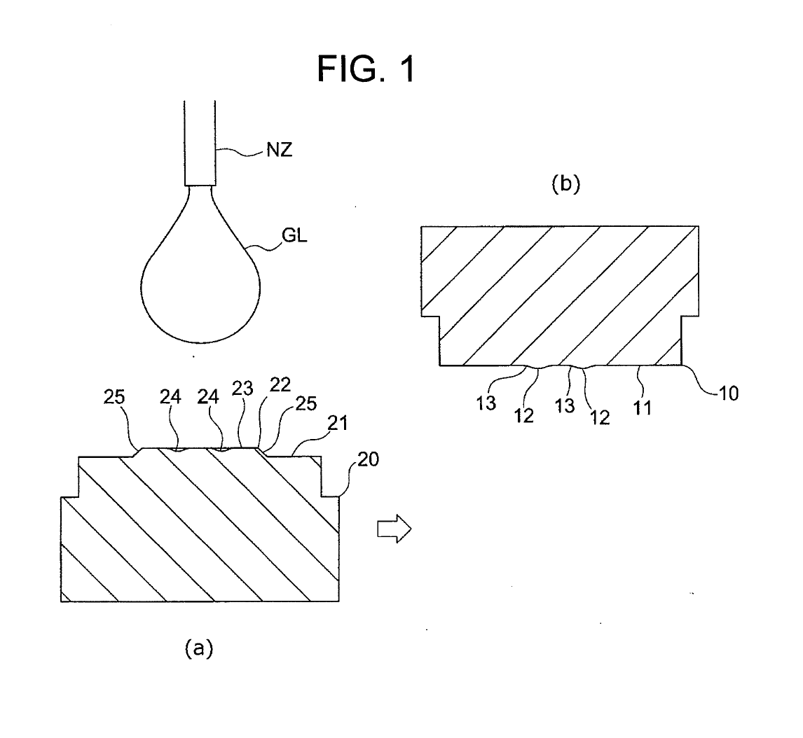

Hereafter, the embodiments of the present invention will be described with reference to drawings. FIGS. 1 to 4 are illustrations showing a process of molding a lens array employed in the present embodiment by using a molding die. On the bottom surface (lower surface) 11 of an upper molding die 10, four optical surface transferring surfaces 12 are formed so as to protrude in the arrangement of two rows and two lines. The periphery of each of the optical surface transferring surfaces 12 is shaped in a circular step portion 13 which protrudes by one step from the bottom surface 11. The upper molding die 10 is made of a hard and brittle material capable of enduring glass molding, such as ultra hard alloy and silicon carbide. A below-mentioned lower molding die 20 is similar to the upper molding die 10.

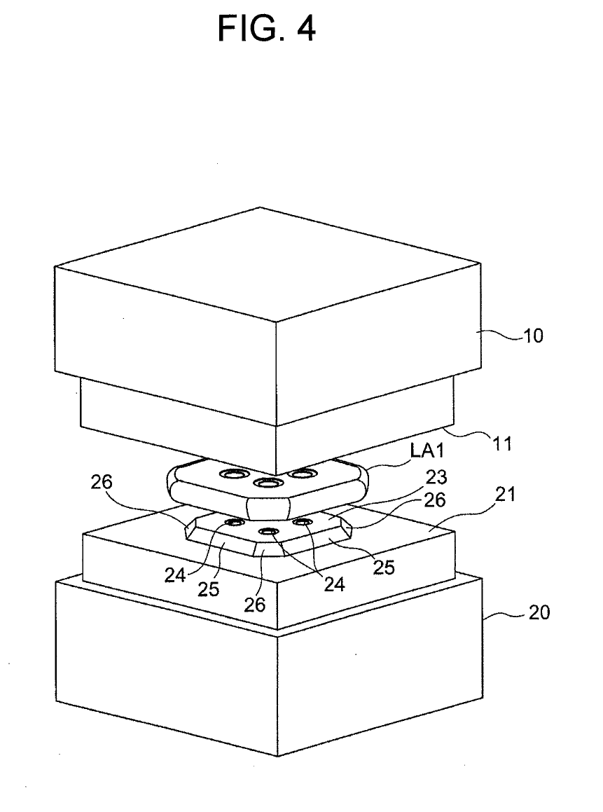

On the other hand, on the top surface (upper surface) 21 of the lower molding die 20, an approximately square-shaped land portion 22 is formed, and on the flat top surface 23 of the land portion 22, four optical surface transferring surfaces 24 are formed so as to become concave in the arrangement of two rows and two lines. On each of the four sides of the land portion 22, a flat surface portion 25 is formed so as to incline at a predetermined angle with respect to the respective optical axes of the optical surface transferring surfaces 24. The two flat surface portions 25 which neighbor so as to make the respective axes orthogonal to each other are connected via a corner portion 26 (refer to FIG. 4). Such a flat surface portion 25 can be formed with sufficient accuracy by machining with a milling cutter and the like. On the land portion 22, a concave portion used to transfer a mark to indicate a direction may be disposed. Further, a number used to discriminate each of the optical surface transferring surfaces 24 may be disposed at a position other than the optical surface transferring surfaces 24.

The multiple optical surface transferring surfaces of the molding die can be formed through grinding processing with a grinding stone by using an ultra-precision processing machine. After the grinding processing, in order to remove grinding traces, the optical surface transferring surfaces are subjected to a polishing process so that each of them can be finished into a mirror surface. The positional accuracy of each of optical surfaces can be confirmed such that a distance from the flat surface portion 25 to the optical surface transferring surface 24 and a distance between the two optical surface transferring surfaces 24 are measured with the use of a three-dimensional measuring instrument and the resulting measurements are checked whether to fall within a predetermined specification.

Next, description will be given to the molding of a lens array with reference to FIGS. 1 to 4. In the case where a lens array including a plurality of optical surfaces as with the present invention is collectively molded by press-molding between the molding dies, any one of the following two methods may be employed.

In the first method (1), as with the conventional glass lens molding, a preform is preliminarily prepared so as to be shaped in an approximate form of a lens portion. A plurality of such preforms are separately arranged on the respective molding surfaces of a molding die and molded by heating and cooling.

In the second method (2), a liquefied molten glass is dropped from an upper portion onto the molding surface and molded by cooling without heating. In the present invention, in view of a constitution to mold a glass lens array, it is preferable to employ the second method (2). The reason is that it becomes possible to enlarge a difference in thickness between a lens portion and a non lens portion (a portion between two lenses of a plurality of lenses or a portion forming an end portion of an intermediate fabrication component). Further, according to a preferable method, it is preferable to drop collectively a large glass droplet, i.e., a molten glass droplet with a volume capable of being filled sufficiently into at least two molding surfaces without dropping a glass droplet separately into each molding surface. Furthermore, according to a more preferable method, a dropping position is determined so as to drop the large molten glass droplet at a position located with an equal distance from each of a plurality of molding surfaces expected to be filled with a glass droplet. With the employment of the above methods, it becomes possible to minimize a time difference among the respective time periods of the molding surfaces to take for being filled separately with a glass droplet. Accordingly, it becomes possible to minimize a shape difference among the molded lens shapes and a bad influence to optical performance. Naturally, in consideration of the above time difference, small glass droplets may be dropped separately simultaneously into respective molding surfaces, thereby attaining the similar effects. However, in order to make glass into such small glass droplets, an apparatus becomes large and complicate in terms of constitution. Accordingly, the former is more preferable.

Namely, in the case of a large droplet in the former, as shown in FIG. 1(a), the lower molding die 20 is located beneath a platinum nozzle NZ which communicates with a storage section (not-shown) which stores heated molten glass, and a liquid droplet of the molten glass GL is dropped collectively from the platinum nozzle NZ toward a position on the top surface 21 which is located with an equal distance from each of the plurality of optical surface transferring surfaces 24. In this state, since the viscosity of the glass GL is low, the dropped glass GL spreads on the top surface 21 so as to wrap up the land portion 22 so that the shape of the land portion 22 is transferred onto the glass GL. Further, in the case of dropping separately small liquid droplets in the latter, a comparatively-large liquid droplet of the glass GL is made to pass through four small holes so as to be separated into four small liquid droplets while adjusting the quantity of each liquid droplet, and the four small liquid droplets are fed separately approximately simultaneously onto the top surface 21. When liquefied molten glass is dropped, since an air pocket tends to take place among the respective molding surfaces, it is necessary to consider sufficiently the dropping condition to drop the molten glass such as volume.

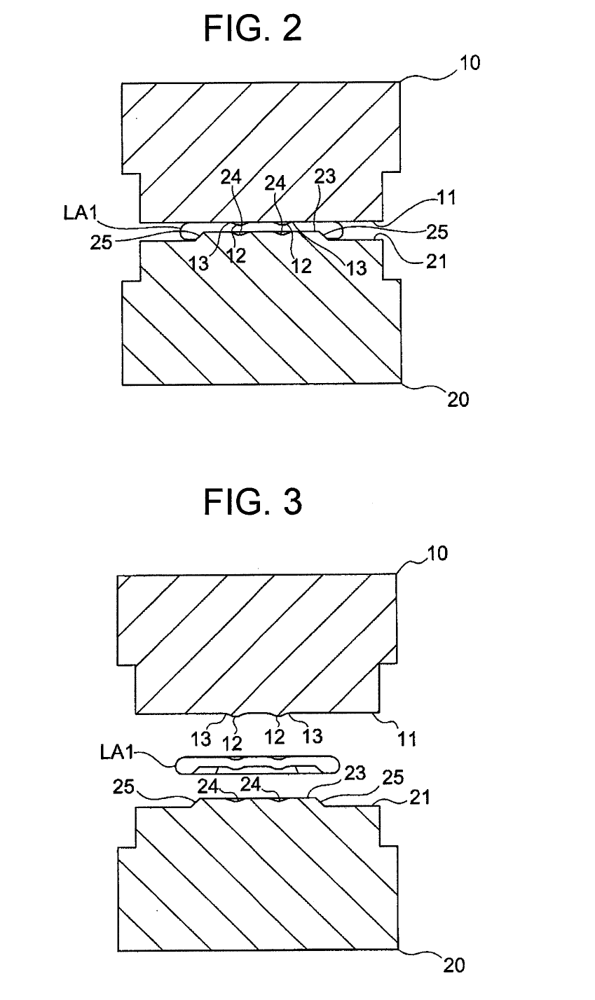

Successively, before the glass GL cools, the lower molding die 20 is made approach a position which is located beneath the upper molding die 10 shown in FIG. 1 (b) and faces the upper molding die 10, and the lower molding die 20 is aligned with the upper molding die 10. Further, as shown in FIG. 2, molding is performed by making the upper molding die 10 and the lower molding die 20 approach each other with the use of a not-shown guide. With this operation, onto the top surface of the flattened glass GL, the optical surface transferring surfaces 12 and the circular step portions 13 of the upper molding die 10 are transferred, and onto its bottom surface, the shape of the land portion 22 of the lower molding die 20 is transferred. At this time, while the bottom surface 11 of the upper molding die 10 and the top surface 21 of the lower molding die 20 are held in parallel to each other and separated from each other with a predetermined distance, the glass GL is made cool. The glass GL solidifies in the state that the glass GL is flattened so as to surround around the periphery and the shape of the flat surface portion 25 is transferred onto the glass GL.

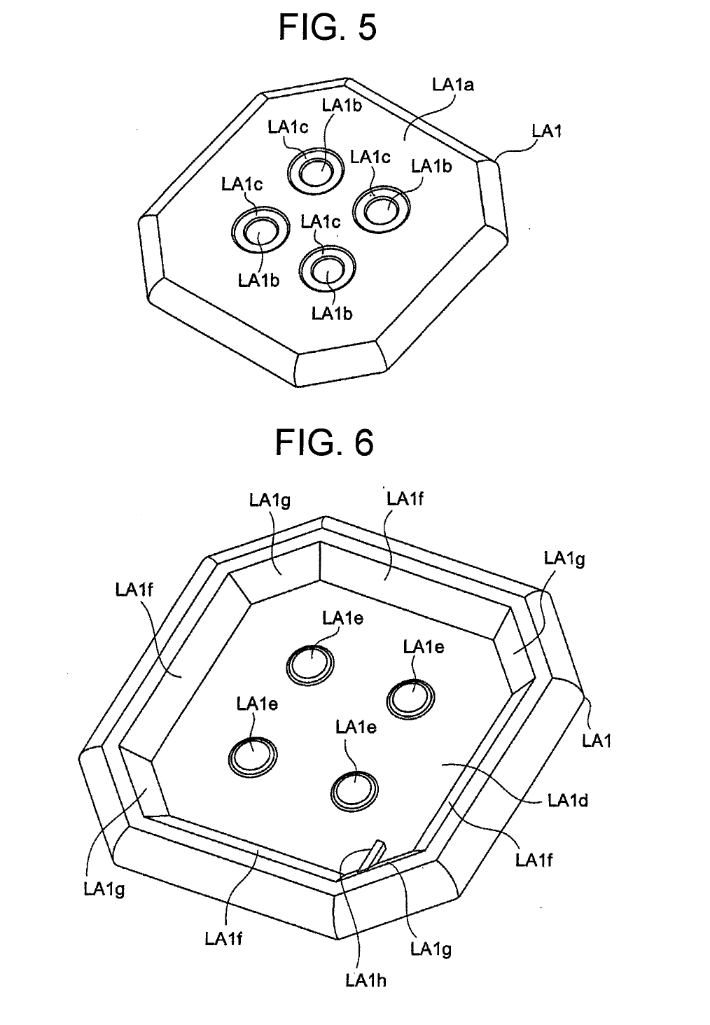

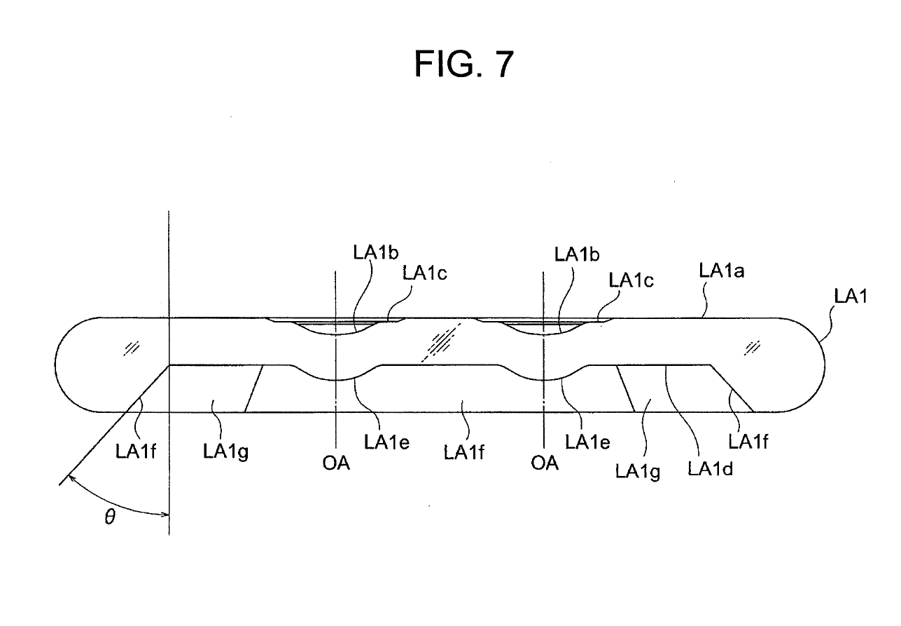

Subsequently, as shown in FIGS. 3 and 4, the upper molding die 10 and the lower molding die 20 is made to separate from each other, and the glass GL is taken out, thereby forming a glass lens array LA1. FIG. 5 is a perspective view of the front side of the glass lens array LA1, and FIG. 6 is a perspective view of its back side. Further, FIG. 7 is a cross-sectional view of the glass lens array LA1 at a position including the optical axis.

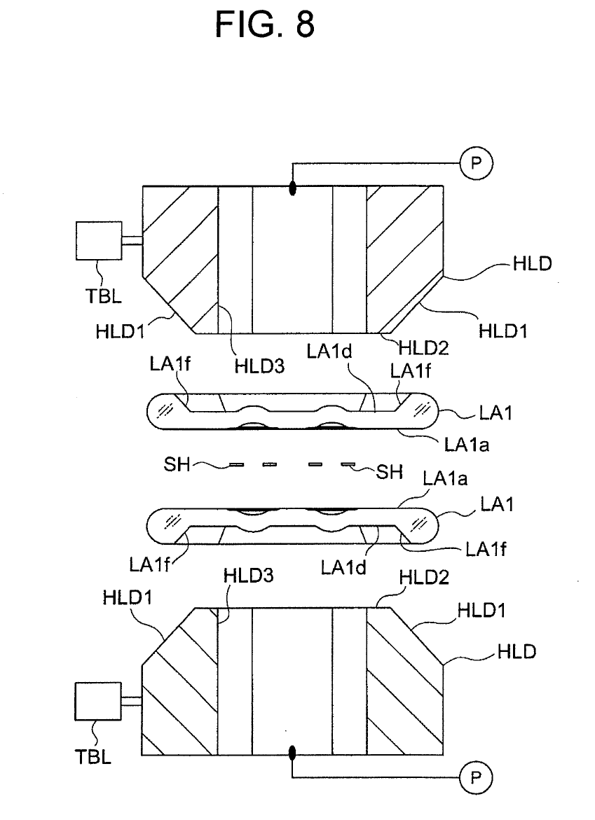

As shown in the drawings, the glass lens array LA1 is shaped in a thin square (or octagon) plate as a whole. The glass lens array LA1 includes a top surface LA1a which is transferred and molded from the bottom surface 11 of the upper molding die 10 and is a highly precise flat surface; four concave optical surfaces LA1b which are transferred from the optical surface transferring surfaces 12 onto the top surface LA1a; and shallow circular grooves LA1c which are transferred from the circular step portions 13 to the respective peripheries of the concave optical surfaces LA1b. The circular grooves LA1c are used, for example, to accommodate respective light shielding members SH (refer to FIG. 8).

Further, the glass lens array LA1 includes a bottom surface LA1d which is transferred from the top surface 23 of the land portion 22 of the lower molding die 20 and is a highly precise flat surface; four convex optical surfaces LA1e which are transferred and molded from the optical surface transferring surface 24 onto the bottom surface LA1d, and first flat surfaces LA1f and corner connecting portions LA1g which are transferred respectively from the flat surface portions 25 and the corner portions 26 of the land portion 22. A reference symbol LA1h represents a mark which is transferred simultaneously and indicates a direction. The first flat surfaces LA1f and the corner connecting portions LA1g constitute an inner peripheral surface.

In FIG. 7, each of the first flat surfaces LA1f is made incline at an angle of 10° to 60° (here, 45°) with respect to each of the respective optical axes OA of the optical surfaces.

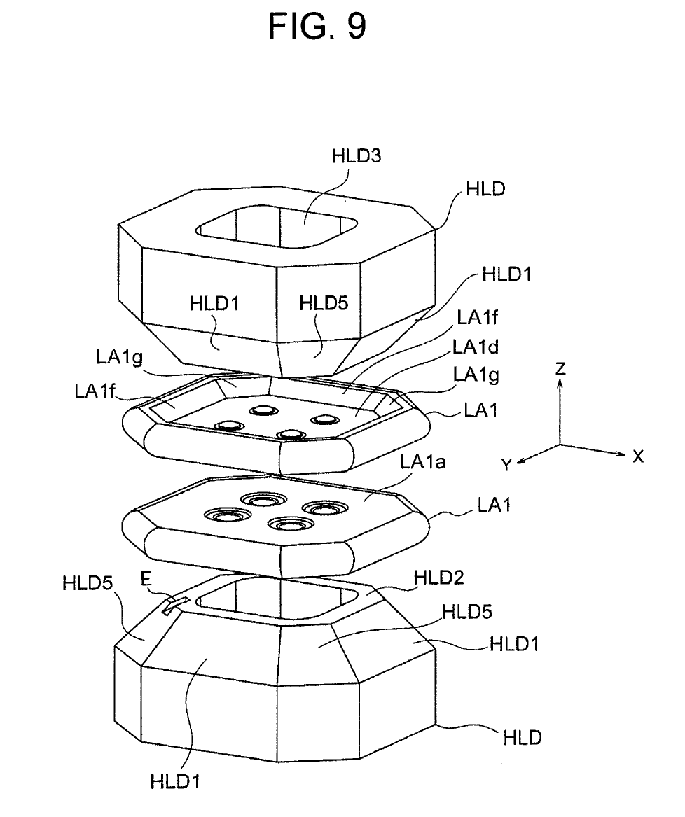

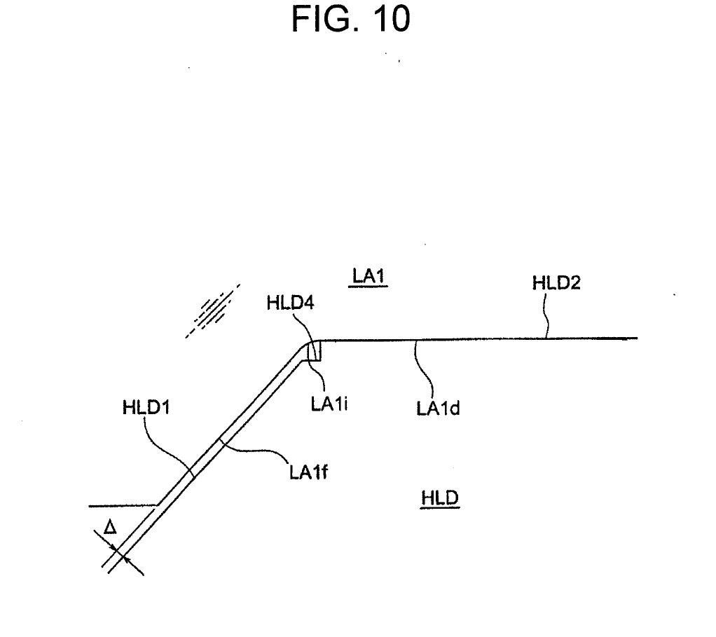

Next, description will be given to a process of forming an intermediate fabrication component 1M by pasting a glass lens array molded separately in the similar manner to that of the glass lens array LA1 onto the glass lens array LA1. FIG. 8 is a cross-sectional view showing holders HLD to hold the respective back surfaces of the glass lens arrays LA1, and FIG. 9 is a perspective view. The holders HLD are mounted on a XYZ table TBL capable of moving three dimensionally. Here, it is presupposed that a direction along the optical axis of the optical surface is made a Z direction, and directions orthogonal to the Z direction are made an X direction and a Y direction respectively.

The holder HLD shaped in a rectangular barrel includes tapered surfaces HLD1 on its external periphery at the holding side and end surfaces HLD2 which intersects with the respective tapered surfaces HLD1. The tapered surfaces HLD1 each of which serves as a second flat surface are provided by four in response to the number of the first flat surfaces LA1f of the glass lens array LA1, and each of the tapered surfaces HLD1 is made incline by 45° with respect to the axis of the central opening HLD3 of the holder HLD. The central opening HLD3 has a size capable of surrounding the optical surfaces LA1e of the glass lens array LA1. Therefore, the end surfaces HLD2 are enabled to come in contact with the bottom surface LA1d of the glass lens array LA1. The back surface side of the central opening HLD3 is connected to a negative pressure source P. Here, the two tapered surfaces HLD1 neighboring on each other are connected via a corner tapered surface HLD5. The tapered surfaces HLD1 and the corner tapered surfaces HLD5 constitute an outer peripheral surface. It may be preferable to form an escape portion (concave portion) E configured to receive the mark LA1h at a part from one of the end faces HLD2 to one of the corner tapered surfaces HLD5.

It is preferable that the holder HLD is made of a stainless material, and subjected to quenching treatment in order to suppress abrasion and deformation, whereby hardness is made HRC 56 or more. Further with regard to a distance between the two tapered surfaces HLD1 facing each other, an amount of shrinkage at the time of molding of a lens array is calculated, and then the distance is preferably determined in consideration of the amount of shrinkage as a feedback value.

From the state shown in FIGS. 8 and 9, when the holder HLD is made approach the glass lens array LA1, the end surfaces HLD2 are brought in contact with the bottom surface LA1d of the glass lens array LA1. In this state, when the inside of the central opening HLD3 is made into a negative pressure, the glass lens array LA1 is adsorbed and held by the holder HLD. In this state, the first flat surfaces LA1f of the glass lens arrays LA1 face the respective tapered surfaces HLD1 of the holder HLD with a clearance Δ of 10 μm or less (for example, 2 μm) (refer to FIG. 10), or come in contact with the respective tapered surfaces HLD1. Further, the corner connecting portions LA1g face the respective corner tapered surfaces HLD5 with a clearance equal to or more than the above clearance.

When the first flat surfaces LA1f come in contact with the respective tapered surfaces HLD1, the glass lens array LA1 cannot rotate more than that for the holder HLD. Meanwhile, since the tapered surfaces HLD1 are regulated by the respective opposite first flat surface LA1f, the glass lens array LA1 cannot move more than that relatively to the holder HLD. That is, by holding the glass lens array LA1 with the holder HLD, the glass lens array LA1 can be positioned with high precision for the holder HLD. Therefore, by positioning the two holders HLD to each other with high precision with the XYZ table TBL, the two glass lens arrays LA1 held respectively by the two holders HLD can be positioned to each other with high precision while facing each other. As a result, with this positioning, all the four optical surfaces can be aligned with high precision.

FIG. 10 is a partially-expanded cross-sectional view in the state that the glass lens array LA1 is held by the holder HLD. On the glass lens array LA1, an R portion (or a chamfered portion) LA1i may be formed between the bottom surface LA1d and the first flat surfaces LA1f. This portion can be formed by rounding an edge portion of the land portion 22 of the lower molding die 20. This portion can prevent chips and fusion from occurring in the molding die, whereby the operating life of the molding die can be prolonged. In this case, by forming an escape portion (roll-off portion) HLD4 (here, a step portion) between the tapered surfaces HLD1 and the end surface HLD2 in the holder HLD, interference is not caused between the both parties even if the R portion is not formed on the glass lens array LA1, whereby the positioning with high precision can be ensured.

The respective top surfaces LA1a of the two glass lens arrays LA1 are coated with a UV curable adhesive (not shown). Successively, as shown in FIG. 8, the two glass lens arrays LA1 held respectively by the two holders HLD are made approach each other while sandwiching the circular light shielding members SH between them, and then, the two top surfaces LA1a are brought in contact with each other. Subsequently, by being irradiated with ultraviolet rays from the outside, the two glass lens arrays LA1 are bonded with each other. As a result, the respective optical axes of the two optical surfaces facing to each other in the two glass lens arrays LA1 are aligned with each other, whereby an intermediate fabrication component with high precision can be produced.

According to the result of investigation by the present inventors, it turned out that in the case where a distance between the first flat surface LA1f and the tapered surface HLD1 is set to 2 μm, the dispersion of axis misalignment between the two optical surfaces can be suppressed to 2 μm or more or less. On the other hand, for example, with the technique disclosed in the pamphlet of the International Publication No. 2011/093502, the axis misalignment between the optical surfaces is caused by about 7 μm as the maximum. As a result of comparison between these axis misalignments, the effect of the present invention can be confirmed.

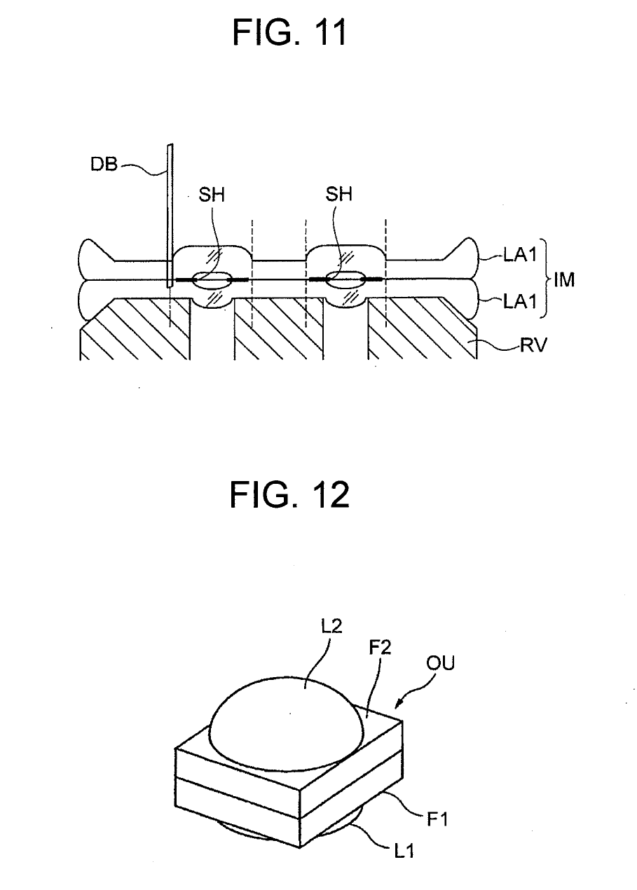

Thereafter, the adsorption through each of the holders HLD is stopped, and the holders HLD are separated from each other, whereby an intermediate fabrication component IM in which the two glass lens array LA1 are pasted to each other can be taken out from the holders HLD. Successively, as shown in FIG. 11, the intermediate fabrication component IM is cut out with a dicing blade DB, whereby as shown in FIG. 12, a lens unit OU can be obtained. At the time of cutting the intermediate fabrication component IM, a taper receiving section RV which has a configuration similar to that of the holder HLD is arranged. Accordingly, a plurality of the intermediate fabrication components IM can be placed side by side on the taper receiving section RV based on the respective first flat surfaces LA1f, whereby it is preferable to cut out a lot of the intermediate fabrication components IM at one time.

The lens unit OU includes a first lens portion L1, a second lens portion L2, a rectangular plate-shaped flange F1 (constituted by a part of each of the top surface LA1a and bottom surface LA1d of the glass lens array LA1) formed around the periphery of the first lens portion L1, a rectangular plate-shaped flange F2 (constituted by a part of each of the top surface LA1a and bottom surface LA1d of the glass lens array LA1) formed around the periphery of the second lens portion L2, and the light shielding member SH disposed between the first lens portion L1 and the second lens portion L2. Subsequently, the molded lens unit OU is subjected to cleaning, and then the both the first lens portion L1 and the second lens portion L2 are applied with an AR coat by an evaporation apparatus.

A modified-embodiment of the present embodiment will be shown below. The number of glass lens arrays should not be limited to two. Three or more glass lens arrays may be superimposed. More specifically, onto an intermediate fabrication component in which multiple glass lens arrays are pasted to each other, another glass lens array is pasted. Such a glass lens array used for superimposing three or more lenses in the above way has a specific configuration on a part thereof.

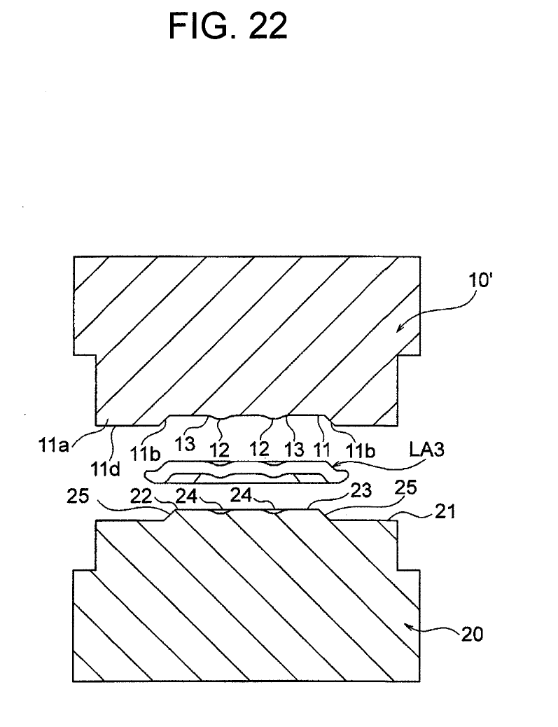

FIG. 22 is a cross-sectional view showing molding dies configured to mold a glass lens array LA3 to be pasted onto an intermediate fabrication component. In FIG. 22, the configuration of the lower molding die 20 is the same as that of the embodiment shown in FIGS. 1 to 4. On the other hand, in the configuration of the upper molding die 10′, a land portion 11a which protrudes by one step is formed in the vicinity of the outer periphery of the bottom surface 11. The land portion 11a has an inner peripheral surface in the form of an octagonal cross section, and, more specifically, the land portion 11a includes long slope surfaces 11b corresponding to the flat surface portions 25 of the lower molding die 20, short slope surfaces (not-shown) corresponding to the corner portions 26 (refer to FIG. 4), and a land flat surface 11d.

At the time of molding according to this modified-embodiment, in the state that the upper molding die 10′ is placed at a non-working position, a glass GL is dropped onto the lower molding die 20. Successively, before the dropped glass GL has cooled, the upper molding die 10′ and the lower molding die 20 are made approach each other, thereby performing molding. With this operation, onto the top surface of the flattened glass GL, the optical surface transferring surfaces 12, the circular step portions 13, and the land portion 11a of the upper molding die 10′ are transferred, and onto its bottom surface, the shape of the land portion 22 of the lower molding die 20 is transferred. At this time, while the bottom surface 11 of the upper molding die 10′ and the top surface 21 of the lower molding die 20 are held in parallel to each other and separated from each other with a predetermined distance, the glass GL is made cool.

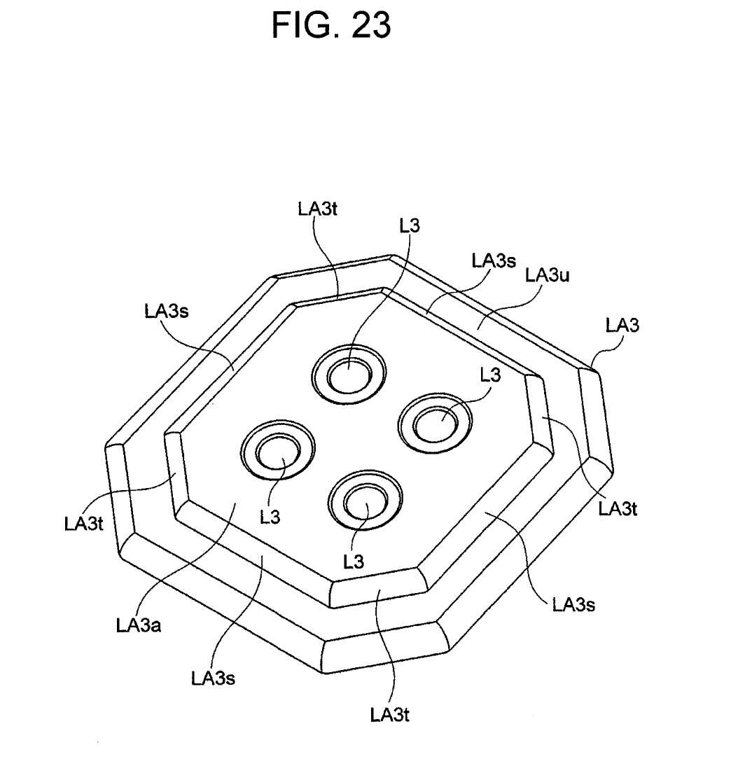

Subsequently, the upper molding die 10′ and the lower molding die 20 are made to separate from each other, whereby a glass lens array LA3 shown in FIG. 23 can be obtained. The glass lens array LA3 is a thin square (or octagon) plate as a whole. The glass lens array LA3 includes a central top surface LA3a which is transferred and molded from the central portion of the bottom surface (lower surface) 11 of the upper molding die 10′ and is a highly precise flat surface; four lens sections L3 which are transferred and formed from the optical surface transferring surfaces 12 onto the central top surface LA3a; four long tapered surfaces LA3s molded around the central top surface LA3a by the long slope surfaces 11b of the upper molding die 10′; four short tapered surfaces LA3t molded around the central top surface LA3a by the short slope surfaces (not shown); and a bottom surface La3u formed by the land flat surface 11d. The back surface of the glass lens array LA3 is molded by the lower molding die 20 in the similar manner to that of the above-mentioned glass lens array LA1.

The long tapered surface LA3s is made incline at an angle of 10° to 60° (here, 45°) with respect to each of the optical axes OA of the optical surfaces.

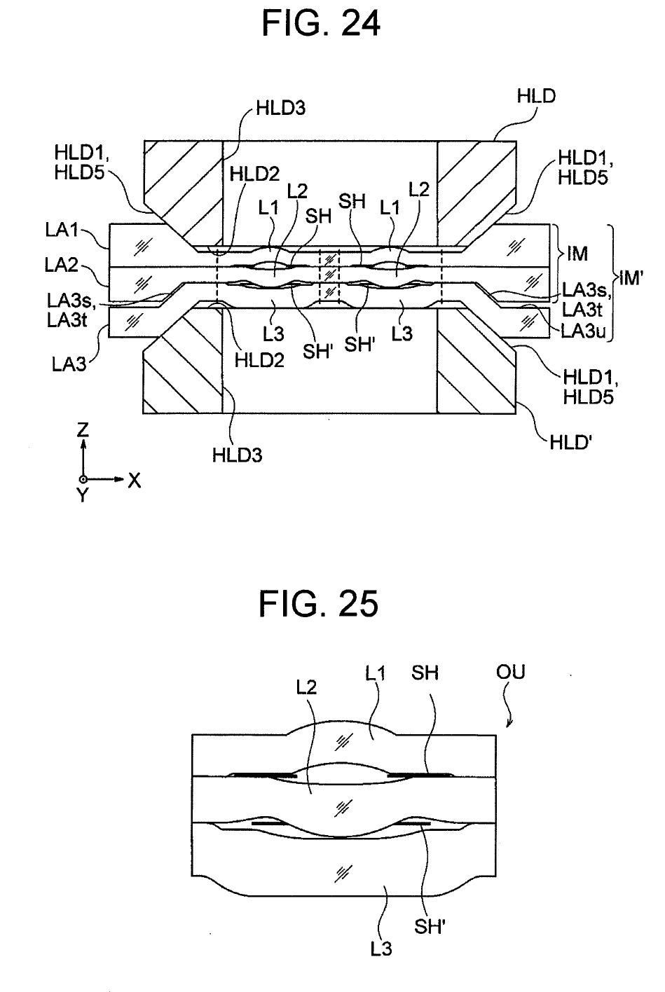

Next, description will be given to a process of forming an intermediate fabrication component 1M′ by pasting the glass lens array LA3 to the intermediate fabrication component 1M. FIG. 24 is a cross-sectional view showing the holder HLD to hold the back surface of the glass lens arrays LA1 in the intermediate fabrication component 1M and a holder HLD′ to hold the back surface of the glass lens arrays LA3. The holder HLD′ is mounted on a XYZ table (not shown) capable of moving three dimensionally. Here, it is presupposed that a direction along the optical axis of the optical surface is made to a Z direction, and directions orthogonal to the Z direction are made to an X direction and a Y direction respectively. The structure of each of the holders HLD and HLD′ is same with that in the above-mentioned embodiment. Therefore, the description for it is omitted.

With reference FIG. 8, the two glass lens arrays LA1 held by the respective holders HLD are made approach each other and pasted to each other so as to form the intermediate fabrication component IM. Successively, by lowering the adsorbing power of the lower holder HLD, the intermediate fabrication component IM becomes the state of being held by the upper holder HLD. In this state, as mentioned above, the glass lens array LA3 held by the holder HLD′ is made approach, from the lower side, the intermediate fabrication component IM in the state that an adhesive agent (not shown) and light shielding members SH′ are interposed between them. When the glass lens array LA3 reaches a predetermined position for pasting, a clearance takes place between the long tapered surfaces LA3s of the glass lens array LA3 and the respective first flat surfaces LA1f of the glass lens array LA1 which faces the glass lens array LA3. Further, a clearance takes place between the short tapered surfaces LA3t of the glass lens array LA3 and the respective second flat surfaces LA1f of the glass lens array LA1 which faces the glass lens array LA3. Furthermore, a clearance takes place between the bottom surface LA3u of the glass lens array LA3 and the lower surface of the glass lens array LA1 which faces the bottom surface.

According to the present embodiment, the intermediate fabrication component IM is held with sufficient precision by the holder HLD, and the glass lens array LA3 is held with sufficient precision by the holder HLD′. Accordingly, by positioning the holder HLD and the holder HLD′ relatively to each other with high precision, the respective optical axes of the lens sections L1 and L2 of the intermediate fabrication component IM side and the optical axis of the lens section LA3 of the glass lens array LA3 can be aligned to each other with high precision. FIG. 25 is a cross-sectional view of a lens unit OU produced by cutting an intermediate fabrication component IM′ shown in FIG. 24 at the positions shown with dotted lines.

According to this modified-embodiment, by superimposing glass lens arrays in the above way, a lens unit OU can be formed at low cost in the state the respective optical axes of three or more lens sections are aligned to each other with high precision.

Furthermore, another modified-embodiment will be shown below. When lens units are cut out from an intermediate fabrication component, if the intermediate fabrication components are cut out one by one, productivity is not improved. On the other hand, if two or more lens units are placed side by side and cut out at one time, productivity is improved. However, if the cut-out positions fluctuate, the dimension accuracy of the lens unit lowers. According to the below-mentioned modified-embodiment, the above problems can be solved.

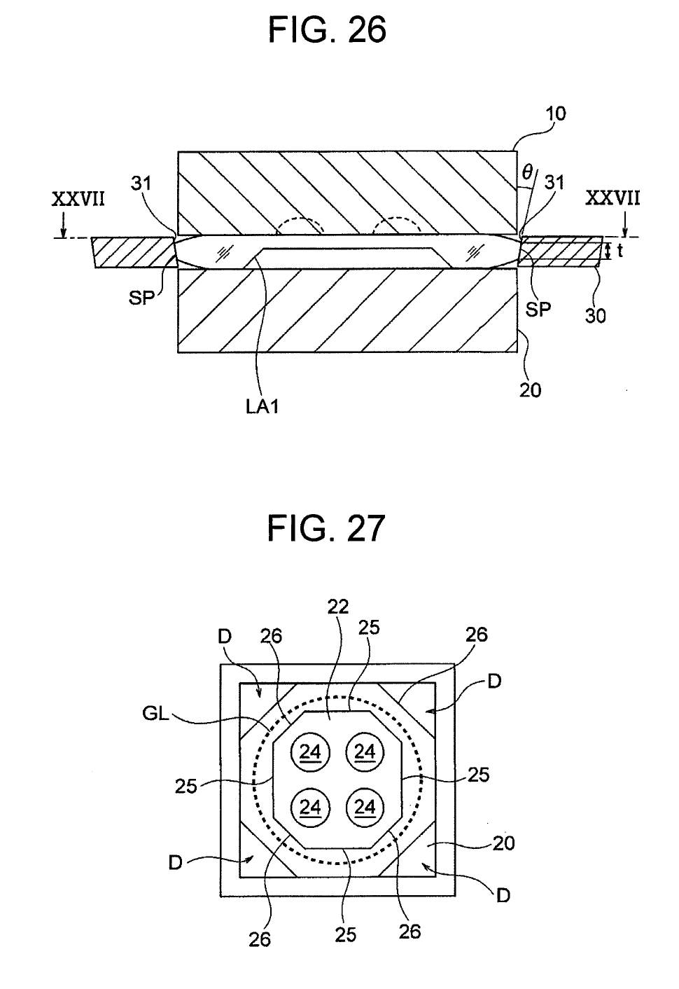

FIG. 26 is a cross-sectional view showing a state at the time of molding of a glass lens array LA1. FIG. 27 is an illustration in which the structure of FIG. 26 is cut out along a XXVII-XXVII line and the cut-out portion is looked in the arrow direction. The molding dies 10 and 20 used for molding are the same as those of the above-mentioned embodiment. However, in the present embodiment, an outer periphery regulating frame 30 is disposed, and at the time of molding, this outer periphery regulating frame 30 is configured to be arranged at the outer periphery side of the glass GL with high precision. The outer periphery regulating frame 30 is shaped in a rectangular frame, and has a tapered inner peripheral surface 31 (which is shaped in the form of a square cross section in FIG. 27 when being looked in the optical axis direction), wherein the tapered inner peripheral surface 31 is made incline with a taper angle θ of 0° to 5° with respect to the respective axes (which are parallel to each of the respective axes of the optical surfaces) of the molding dies 10 and 20.

At the time of molding of the glass lens array LA1, when the molding dies are made approach each other, a glass GL shown with a dotted line is pressed from both the upper and lower sides and expands toward the periphery side as sown with hatching. At this time, since a distance between each one of the flat surface portions 25 of the land portion 22 of the lower molding die 20 and the corresponding one of the four sides of the outer periphery regulating frame 30 is smaller than a distance between each one of the corner portions 26 and the corresponding one of the four corners of the outer periphery regulating frame 30, the expanded glass GL comes in contact with portions of the inner peripheral surface 31 of the outer periphery regulating frame 30 which face the respective four flat surface portions 25. However, the expanded glass GL does not reach the corner portions which face the respective four corner portions 26. As a result, a space D takes place at each of the corner portions. The space D acts as a buffer portion when the volume of the glass GL fluctuates. The outer periphery of the glass GL coming in contact with the space D becomes a naturally-formed free configuration without being regulated into a predetermined configuration. In contrast, among the outer peripheral portion of the expanded glass GL, the contact surface (reference surface) 31a coming in contact with the inner peripheral surface 31 of the outer periphery regulating frame 30 is shaped in a flat surface with high precision. As shown in FIG. 26, it may be sufficient for each of the four contact surfaces SP to have a thickness t of about one third (⅓) of that of the glass lens array LA1. It is not necessary for each of the four contact surfaces SP to have the same thickness to each other.

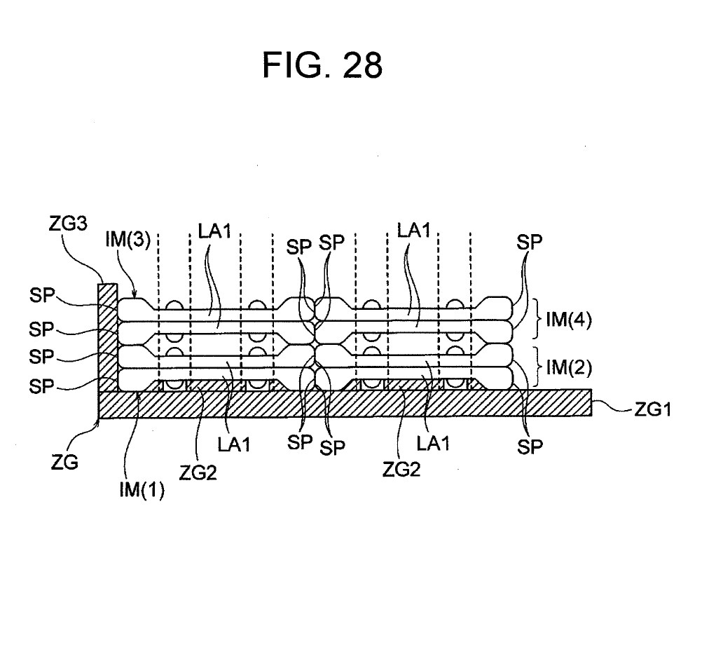

FIG. 28 is an illustration showing the state that a plurality of intermediate fabrication components IM in each of which the glass lens arrays LA1 are pasted to each other as mentioned above are placed side by side and are cut out at one time. In FIG. 28, a jig ZG includes a plurality of holding sections ZG2 (not shown) which are disposed on a base surface ZG1 and configured to adsorb and hold the respective back surfaces of the glass lens arrays LA1 with the utilization of air pressure. Further, at the end portion of the base surface ZG1, a vertical wall ZG3 extending vertically is disposed.

As mentioned above, in the intermediate fabrication component IM, since the respective axes of the lens sections are aligned to each other with high precision by using the holders, the respective contacts surfaces SP of the glass lens arrays LA1 in the intermediate fabrication component IM are also aligned to each other. As a preliminary process of cutting, first, an intermediate fabrication component IM (1) is disposed on the base surface ZG1 such that one of the contact surfaces SP of a glass lens array LA1 is brought in contact with the vertical wall ZG3, and then the intermediate fabrication component IM (1) is held by the holding section ZG2. Next, an intermediate fabrication component IM (2) is disposed on the base surface ZG1 such that one of the contact surfaces SP of another glass lens array LA1 is brought in contact with the other one of the contact surface SP of the glass lens array LA1, and then the intermediate fabrication component IM (2) is held by the neighboring holding section ZG2. Thereafter, in the similar manner, a plurality of the intermediate fabrication components IM are aligned in one line

Successively, on the intermediate fabrication component IM (1) which belongs to the first line and comes in contact with the vertical wall ZG3, a not-shown adhesive agent (which can be cleaned up with chemicals in a post process) is filled up. Thereafter, another intermediate fabrication component IM (3) is disposed and fixed such that the intermediate fabrication component IM (3) is superimposed on the intermediate fabrication component IM (1) and one of the contact surfaces SP of another glass lens array LA1 is brought in contact with the vertical wall ZG3. Subsequently, on the intermediate fabrication component IM (2) which belongs to the first line, an intermediate fabrication component IM (4) is arranged such that one surface of the contact surfaces SP of another glass lens array LA1 is brought in contact with the other one of the contact surfaces SP in the intermediate fabrication component IM (3), and then the intermediate fabrication component IM (4) is fixed with the filled-up adhesive agent. In the following, in the same way, on the intermediate fabrication components IM in the first line, the intermediate fabrication components IM can be superimposed to form the second line. Further, the intermediate fabrication components IM can be arranged lengthwise and breadthwise in the direction vertical to the paper surface of the drawing such that respective contact surfaces SP are brought in contact with each other.

Then, the superimposed intermediate fabrication components IM are cut out at one time at positions indicated with dotted lines as shown in FIG. 28 with a not-shown dicing blade, whereby a lens unit OU as shown in FIG. 12 can be obtained. The lens units connected to each other by the adhesive can be separated by removing the adhesive with chemical cleaning at the post process.

In the case where each of the contact surfaces SP is formed as a reference surface on the outer periphery of the glass lens array LA1 at the time of molding of the glass lens array LA1, even if such the contact surfaces SP are employed, it may be difficult to align the glass lens arrays to each other with high precision so as to align the respective optical axes to each other. However, it is possible to ensure the accuracy to satisfy sufficiently the requested dimensions of the lens unit OU. Therefore, with the process that a plurality of intermediate fabrication components IM are aligned on the basis of the contact surfaces SP, superimposed on each other, and cut out at one time, the productive efficiency of lens units OU can be enhanced.

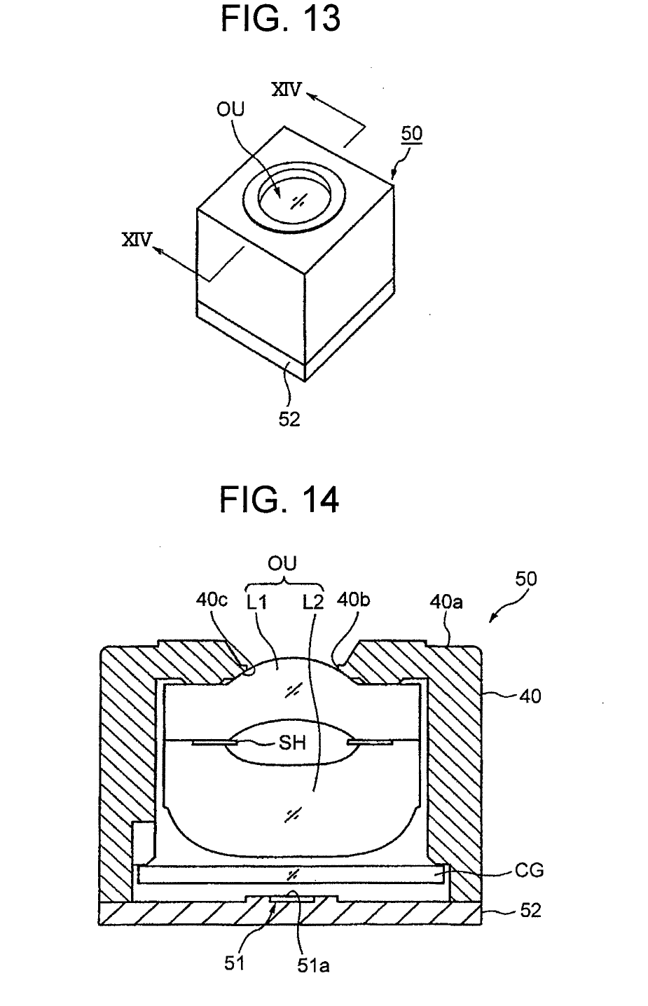

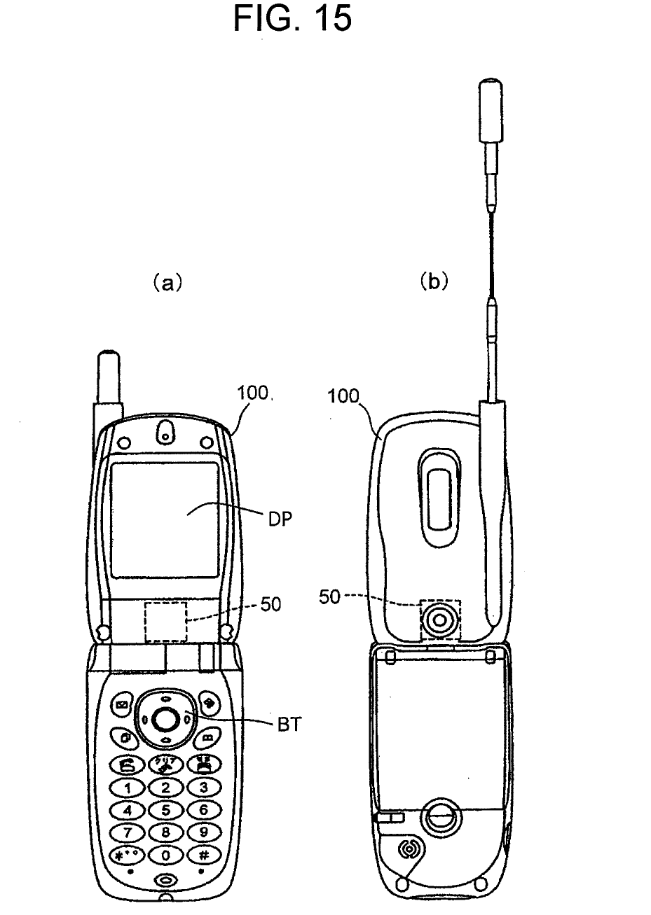

FIG. 13 is a perspective view of an image pickup device 50 which employs the lens unit according to the present embodiment, and, FIG. 14 is a cross-sectional view of the structure shown in FIG. 13 which is cut out along a XIV-XIV line and viewed in the direction of an arrow. As shown in FIG. 14, the image pickup device 50 includes a CMOS type image sensor 51 which has a photoelectric conversion unit 51a and acts as a solid state image pickup element; a lens unit OU which allows the photoelectric conversion unit 51a of the image sensor 51 to pick up an image of an object; and a base board 52 which holds the image sensor 51 and includes an external connection terminal (not-shown) which performs transmission and reception of electric signals, and these components are formed integrally.

In the above image sensor 51, the photoelectric conversion unit 51a acting as a light receiving section is formed at the central portion of a flat surface of the light receiving side of the image sensor 51, and in the photoelectric conversion unit 51a, pixels (photoelectric conversion elements) are arranged in a two dimensional arrangement. Further, the photoelectric conversion unit 51a is connected to a not-shown signal processing circuit. The signal processing circuit includes a driving circuit to drive pixels sequentially so as to obtain signal charges; an A/D converting section to convert each of the signal charges into digital signals; a signal processing section to form image signal outputs by using the digital signals, and the like. Further, in the vicinity of the outer edge of the flat surface at the light receiving side of the image sensor 51, a number of pads (not shown) are arranged, and connected to the base board 52 via wiring (not shown). The image sensor 51 is configured to convert the signal charges from the photoelectric conversion unit 51a into image signals such as digital YUV signals, and outputs the image signals to a predetermined circuit on the base board 52 via wiring (not shown). Here, Y represents luminance signals, U (=R−Y) represents color difference signals between red and the luminance signals, and V (=B−Y) represents color difference signals between blue and the luminance signals. Further, the solid state image pickup elements should not be limited to the above-mentioned CMOS type image sensors, and other sensors, such as CCD may be employed.

The base board 52 which supports the image sensor 51 is connected to the image sensors 51 via not-shown wiring so as to be able to communicate with the image sensors 51.

The base board 52 is connected to an external circuit (for example, a control circuit incorporated in a high rank device of a mobile terminal in which the image pickup device is mounted) via not-shown external connection terminals, so that the base board 52 is enabled to receive the supply of voltage and clock signals to drive the image sensor 51 from the external circuit and to output the digital YUV signals to the external circuit.

The upper part of the image sensor 51 is sealed with a not-shown cover glass, and above the cover glass, an IR cut-off filter CG is disposed between the second lens portion L2 and the cover glass. In a hollow rectangular tube-shaped mirror frame 40, the bottom portion is opened and the top portion is covered with a flange portion 40a. On the center of the flange portion 40a, an opening 40b is formed. In the inside of the mirror frame 40, the lens unit OU is disposed.

The lens unit OU includes, in the order from an object side (the upper side in FIG. 14), an aperture diaphragm as which an opening edge of the mirror frame functions, a first lens portion L1, a light shielding member SH to shield unnecessary light, and a second lens portion L2. As mentioned above, since each of the first lens portion L1 and the second lens portion L2 is made of glass, they are excellent in optical properties. In the present embodiment, when the first lens portion L1 is misaligned, the tapered inner peripheral surface 40c of an opening 40b is configured to come in contact with the optical surface of the first lens portion L1 or a curved surface extended from the optical surface (however, a flange surface is not included), thereby regulating the position of the first lens portion L1. With this, only by mounting the mirror frame 40 on the base board 52, the light receiving surface of the image sensor 51 can be positioned with sufficient accuracy at the focal position of the lens unit OU.

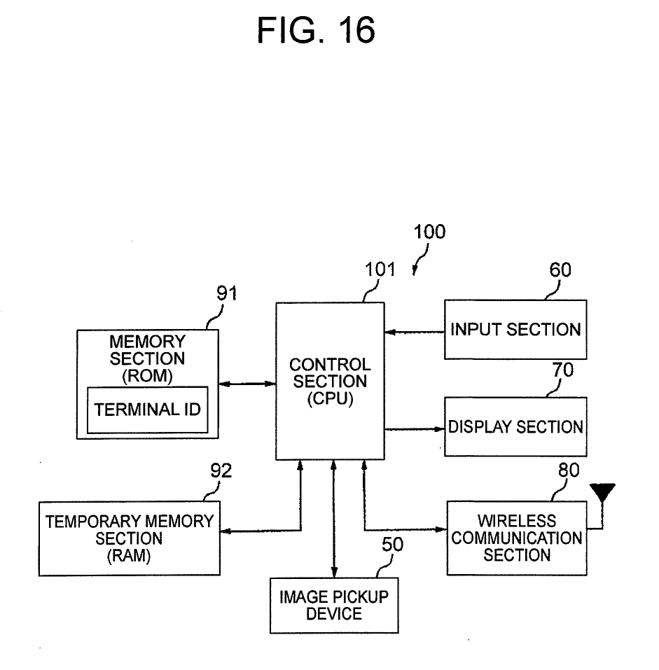

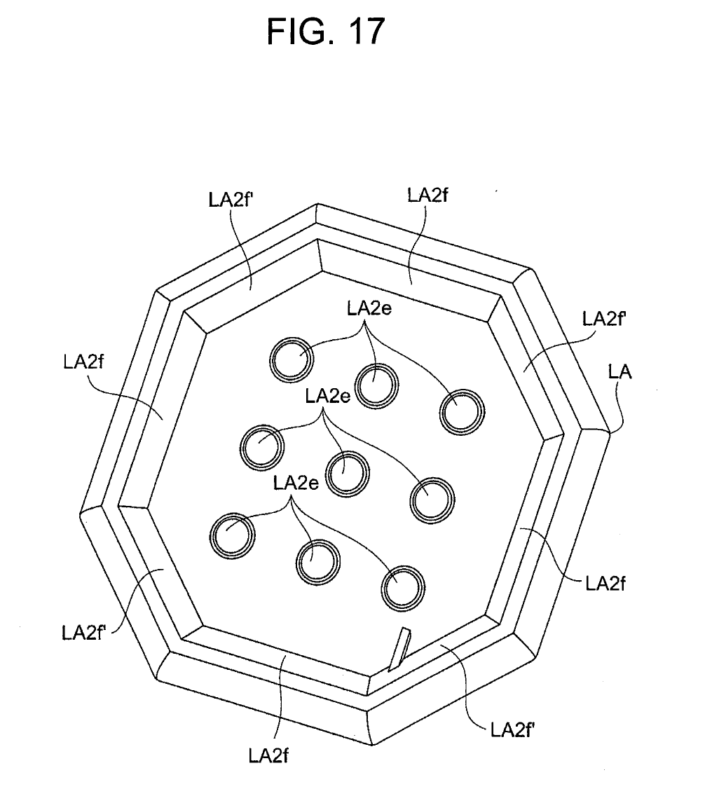

Next, the operation mode of the above-mentioned image pickup device 50 will be described. FIGS. 15(a) and 15(b) are illustrations showing the state of incorporating the image pickup device 50 in a mobile telephone 100 as a mobile terminal which is a digital device. Further, FIG. 16 is a control block diagram of the mobile telephone 100.

The image pickup device 50 is disposed such that, for example, as shown in FIG. 15(b), the object side end surface of the lens unit OU is disposed at the back surface (the liquid crystal display DP side shown in FIG. 15(a) is made a front surface) of the mobile telephone 100, and arranged at a position corresponding to the lower side of the liquid crystal display DP.

The external connection terminals (not shown) of the image pickup device 50 are connected to the control section 101 of the mobile telephone 100, and the image pickup device 50 outputs image signals such as luminance signals and color difference signals to the control section 101 side.

On the other hand, as shown in FIG. 16, the mobile telephone 100 includes the control section (CPU) 101 which controls collectively each section and executes programs corresponding to each of processing operations; an input section 60 which inputs numbers and the like via keys; a display section 70 to display photographed images and pictures; a wireless communicating section 80 to attain various information communications with external servers; a memory section (ROM) 91 which stores system programs and various processing programs of the mobile telephone 100 and necessary various data such as terminal IDs; and a temporary memory section (RAM) 92 which is used as a working region to store temporarily various processing programs to be executed by the control section 101, data or processing data, and image pickup data by the image pickup device 50.

When the lens unit OU of the image pickup device 50 is directed to face an object by a photographer holding the mobile telephone 100, image signals corresponding to still images or moving images are picked up into the image sensor 51. Namely, when the photographer pushes down a button BT indicated in FIG. 15(a) at a desired shutter chance, a release operation is performed, and image signals are picked up into the image pickup device 50. The image signals input from the image pickup device 50 are transmitted to the control system of the above-mentioned mobile telephone 100, then, stored in the memory section 92 or displayed on the display section 70, and further expected to be transmitted as image information to the outside.

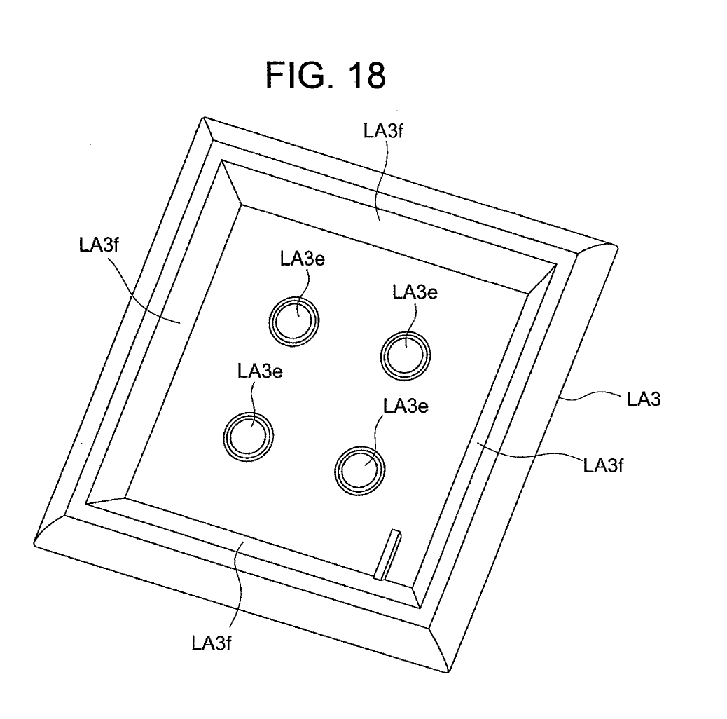

FIG. 17 is a perspective view of a glass lens array LA2 according to another embodiment. The glass lens array LA2 shown in FIG. 17 is shaped in an approximately right octagon, and includes another first flat surface LA2f′ between the two neighboring first flat surfaces LA2f of four first flat surfaces LA2f. Accordingly, a holder to hold the glass lens array LA2 is made also have two sets of tapered surfaces. In the present embodiment, optical surfaces LA2e are arranged in the form of three rows and three lines. Other matters except these matters are the same with those in the above-mentioned embodiment.

With only the four first flat surfaces LA2F, the direction at an angle of 45° (corner direction) is separated from the center of the lens array. Accordingly, due to the reason that the material shrinkage ratio at the time of molding becomes different for each angle, there is possibility that the accuracy of transferring deteriorates. However, by making the first flat surfaces into multiple surfaces (octahedral surfaces and the like), the distance from the center of the lens array to each of the first flat surfaces LA2f and LA2F′ becomes short, which results in that the transferring capability can be expected to be improved. Further, by making the first flat surfaces into multiple surfaces (octahedral surfaces and the like) so as to make the area of the flat surface small, a glass droplet tends to be flattened easily, which reduces a load in molding. As a result, the improvement of yield and the enhancement of the operation life of the molding die can be attempted.

FIG. 18 is a perspective view of a glass lens array LA3 according to another embodiment. In the present embodiment, the two neighboring first flat surfaces LA3f of four first flat surfaces LA3f are made intersect to each other such that the respective axes of the two neighboring first flat surfaces LA3f are orthogonal to each other. Other matters except these matters are the same with those in the above-mentioned embodiment.

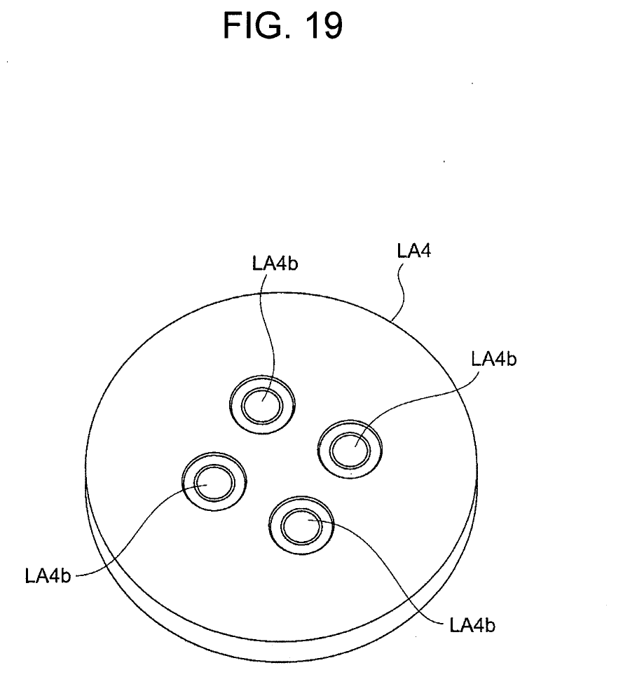

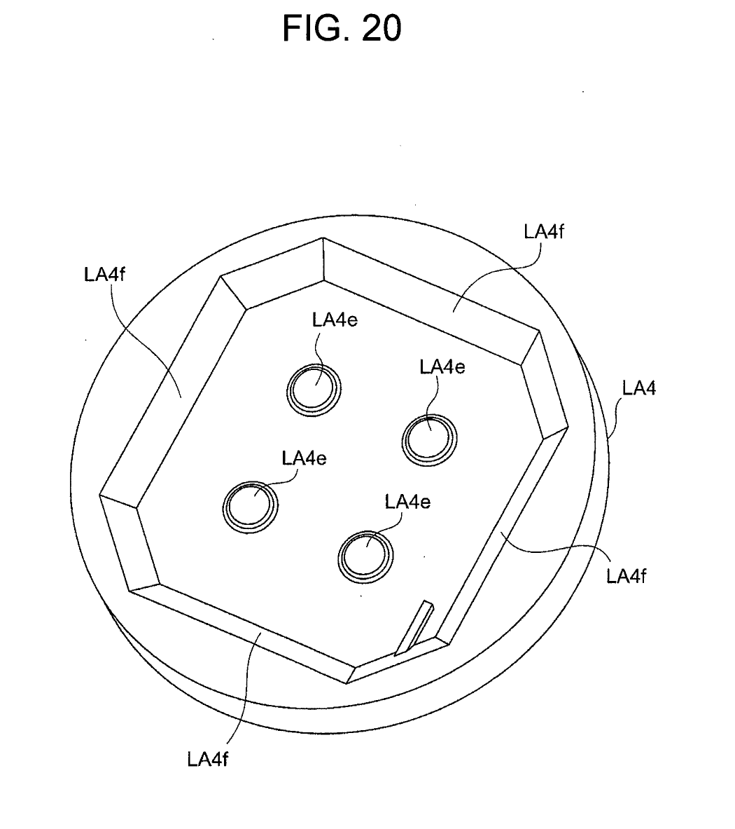

FIG. 19 is a perspective view of the front side of a glass lens array LA4 according to another embodiment, and FIG. 20 is a perspective view of the back side of it. In the present embodiment, the configuration at the inner side from the inner peripheral surface of a glass lens array LA4 is the same as that in the glass lens array LA1. However, the configuration of the outer periphery of the glass lens array LA4 is shaped in the form of a disc. Other matters except these matters are the same with those in the above-mentioned embodiment.

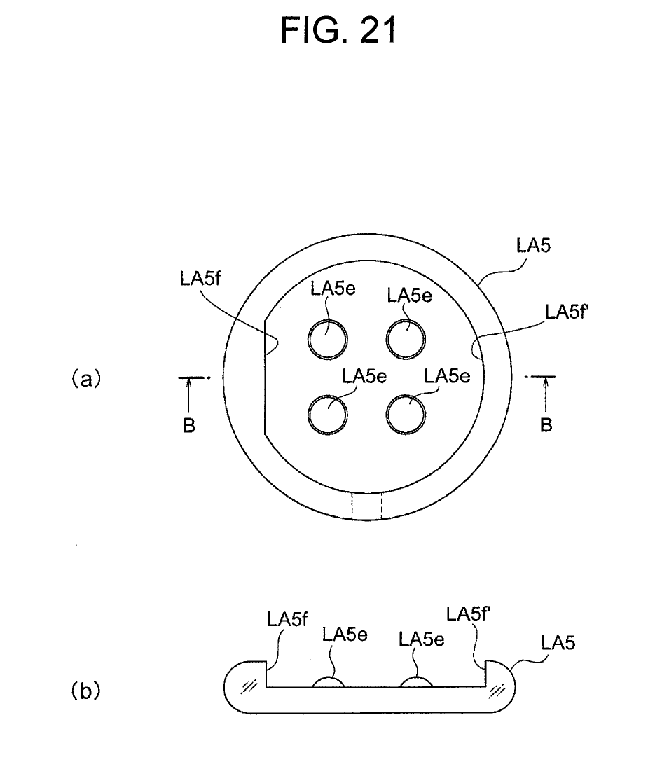

FIG. 21(a) is an illustration in which a glass lens array LA5 according to another embodiment is looked from its back side, and FIG. 21(b) is an illustration in which the structure shown in FIG. 21(a) is cut out along a B-B line, and the cut-out portion is looked from the direction of an arrow. In the present embodiment, a first flat surface LA5f is provided by only one, and other inner periphery except the first flat surface LA5f is made a cylindrical surface LA5f′. The first flat surface LA5f and the cylindrical surface LA5f′ are extended in parallel to each of the optical axes of the optical surfaces LA5e. The present embodiment is suitable to the case where resin is used as material. Other matters except these matters are the same with those in the above-mentioned embodiment. Incidentally, a part of the inner peripheral surface may be cut out as indicated with dotted lined.

Hereafter, the results of the studies conducted by the present inventors will be described. The present inventors investigated the states of the dispersion of axis misalignment of each of the optical surfaces and chips of the molding die by changing a taper angle θ. In the studies, the configuration of the lens array was that shown in FIG. 7 and the material was glass. The results of the studies are shown in Table 1.

TABLE 1

| | taper angle | | | | | | | |
|---|---|---|---|---|---|---|---|---|
| | 0 | 10 | 20 | 30 | 45 | 50 | 60 | 70 |
| dispersion of axis | X | Δ | ◯ | ◯ | ◯ | ◯ | Δ | X |
| misalignment | | | | | | | | |
| operation life of | X | X | Δ | ◯ | ◯ | ◯ | ◯ | ◯ |
| molding die (chips) | | | | | | | | |

◯ A
Δ B
X C

### Evaluation A: Good, B: Ordinary, C: Bad

When the taper angle θ was 45°, the dispersion of axis misalignment of each of the optical surfaces fell within about the half of that of the conventional one, and good results were obtained. However, when the taper angle θ was larger than 60°, the dispersion of axis misalignment of each of the optical surfaces became almost equal to that of the conventional one. On the other hand, when the taper angle θ was smaller than 10°, the transfer ability of molding became bad. Further, when the taper angle θ was smaller than 20°, chips tended to take place easily on the molding die in the course of repeating the molding, and when the taper angle θ was smaller than 10°, the frequency of the occurrence of chips on the molding die increased and the operation life of the molding die became short. From the above, it turned out that, when the taper angle θ is made within an angle of from 30° to 50°, the dispersion of axis misalignment of the optical surface can be suppressed preferably and the operating life of the molding die become preferable.

The present invention should not be limited to the embodiments described in the specification, because it is clear from the embodiments and conception described in the specification for one of ordinary skilled in the art that the present invention includes other embodiments and modified embodiments.

### DESCRIPTION OF REFERENCE SYMBOLS

10 Upper molding die
11 Bottom surface
12 Optical surface transferring surface
13 Circular step portion
20 Lower molding die
21 Top surface
22 Land portion
23 Top surface
24 Optical surface transferring surface
25 Flat surface portion
26 Corner portion
40 Mirror frame
40a Flange portion
40b Opening
40c Inner peripheral surface
50 Image pickup device
51 Image Sensor
51a Photoelectric conversion unit
52 Base board
60 Input section
70 Display section
80 Wireless communicating section
92 Memory section
100 Mobile telephone
OU Lens unit
DB Dicing blade
GL Glass
HLD Holder
HLD1 Tapered surface
HLD2 End face
HLD3 Central opening
HLD4 Escape portion
HLD5 Corner tapered surface
LA1 Glass lens array
LA1a Top surface
LA1b Concave optical surface
LA1c Circular groove
LA1d Bottom surface
LA1e Optical surface, Convex optical surface
LA1f Flat surface
LA1g Corner connecting portion
LA2 Glass lens array
LA2d Flat surface
LA2e Optical surface
LA3 Glass lens array
LA3f Flat surface
LA4 Glass lens array
LA5 Glass lens array
LA5f′ Cylindrical surface
LA5f Flat surface
LA5e Optical surface
NZ Platinum nozzle
RV Receiving portion
SH Shielding member
TBL Table

1. In a lens unit producing method for producing a lens unit from a lens array, wherein in the lens array, a bottom surface including a plurality of optical surfaces and an inner peripheral surface disposed on a periphery of the bottom surface so as to surround the optical surfaces are molded integrally by a molding die, and the inner peripheral surface includes a first flat surface not orthogonal to each of the respective optical axes of the optical surfaces; the lens unit producing method comprising:
a process of moving a holder comprising an outer peripheral surface including a second flat surface and an end surface relatively to the lens array in such a way that the first flat surface and the second flat surface are made approximately parallel to each other and the bottom surface and the end surface are made approach each other in a state that the outer peripheral surface is surrounded by the inner peripheral surface; and
a process of holding the lens array with the holder, and then positioning the lens array by moving the holder.

2. The lens unit producing method of claim 1 wherein two sets of the lens arrays and the holders are prepared, and the lens unit producing method further comprises:
a process of positioning one of the two lens arrays held by one of the two holders to another one of the two lens arrays held by another one of the two holders, and then, pasting the two lens arrays to each other; and
a process of fixing the pasted two lens arrays by using the respective first flat surfaces and cutting the two lens arrays for each of the optical surfaces.

3. The lens unit producing method of claim 2 wherein the lens unit producing method further comprises:
a process of holding the pasted two or more lens arrays by one of the two holders, holding another lens array by another one of the two holders, positioning the two holders to each other, and thereafter, pasting the another lens array and the pasted two or more lens arrays to each other.

4. The lens unit producing method of claim 1, wherein the first flat surface is made inclined with respect to each of the respective optical axes of the optical surfaces.

5. The lens unit producing method of claim 4 wherein the first flat surface has a taper angle of 10° to 60° with respect to each of the respective optical axes of the optical surfaces.

6. The lens unit producing method of claim 1, wherein the first flat surface is prepared by two, and the two first flat surfaces are arranged so as to face each other across the plurality of optical surfaces.

7. The lens unit producing method of claim 1, wherein the first flat surface is prepared by four, and the four first flat surfaces are arranged so as to surround the plurality of optical surfaces, and the respective axes of two neighboring first flat surfaces of the four first flat surfaces are orthogonal to each other.

8. (canceled)

9. The lens unit producing method of claim 1, wherein when the lens array is held by the holder, the end surface is brought in contact with the bottom surface other than the optical surfaces.

10. (canceled)

11. (canceled)

12. The lens unit producing method of claim 1, wherein a reference surface is formed on the outer periphery of the lens array by using the molding die at the time of molding of the lens array, and a plurality of the lens arrays are aligned and superimposed based on the respective reference surfaces, and cut out for each of the optical surfaces at one time.

13. A lens array used for producing a lens unit comprising:
a bottom surface including a plurality of optical surfaces; and
an inner peripheral surface disposed on a periphery of the bottom surface so as to surround the optical surfaces,
wherein the bottom surface and the inner peripheral surface are molded integrally by a molding die, and the inner peripheral surface includes a first flat surface not orthogonal to each of the respective optical axes of the optical surfaces; and
wherein the lens array is prepared by two, and the two lens arrays are held respectively by two holders each comprising an outer peripheral surface including a second flat surface and an end surface in such a way that the first flat surface and the second flat surface are made approximately parallel to each other and the bottom surface and the end surface are made approach each other in a state that the outer peripheral surface is surrounded by the inner peripheral surface, and then, the two lens arrays are subjected to positioning and pasted to each other, and thereafter, the pasted two lens arrays are cut out for each of the optical surfaces, whereby lens units are produced.

14. The lens array of claim 13, wherein the first flat surface is made inclined with respect to each of the respective optical axes of the optical surfaces.

15. The lens array of claim 14, wherein the first flat surface has a taper angle of 10° to 60° with respect to each of the respective optical axes of the optical surfaces.

16. The lens array of claim 13, wherein the first flat surface is prepared by two, and the two first flat surfaces are arranged so as to face each other across the plurality of optical surfaces.

17. The lens array of claim 13, wherein the first flat surface is prepared by four, and the four first flat surfaces are arranged so as to surround the plurality of optical surfaces, and the respective axes of two neighboring first flat surfaces of the four first flat surfaces are orthogonal to each other.

18. (canceled)

19. The lens array of claim 13, wherein when the lens array is held by the holder, the end surface is brought in contact with the bottom surface other than the optical surfaces.

20. (canceled)

21. The lens array of claim 13, wherein a material of the lens array is glass.

22. The lens array of claim 13, wherein the lens array has a reference surface formed on an outer periphery at the time of molding by using the molding die.

23. A lens unit formed by a process of preparing the lens array according to claim 13 by multiple pieces, superimposing the multiple lens arrays, and cutting the superimposed multiple lens arrays.

24. A lens unit formed by a process of preparing the lens array according to claim 22 by multiple pieces, aligning and superimposing the multiple lens arrays based on the respective reference surfaces, and cutting the superimposed multiple lens arrays for each of the optical surfaces at one time.
